(19) United States
(12) Patent Application Publication
(10) Pub. No.: US 2025/0298971 A1
(43) Pub. Date: Sep. 25, 2025

(54) SUMMARY GENERATION FOR LIVE SUMMARIES WITH USER AND DEVICE CUSTOMIZATION

(71) Applicant: GOOGLE LLC, Mountain View, CA (US)

(72) Inventors: Ruofei Du, San Francisco, CA (US); Alex Olwal, Santa Cruz, CA (US); Vikas Bahirwani, San Francisco, CA (US); Boris Smus, Seattle, WA (US)

(21) Appl. No.: 18/862,089

(22) PCT Filed: May 10, 2023
(86) PCT No.: PCT/US2023/021767

§ 371 Date: Oct. 31, 2024

Related U.S. Application Data
(60) Provisional application No. 63/364,478, filed on May 10, 2022.

(51) Int. Cl. G06F 40/20; G06F 3/0485; G10L 15/18; G10L 15/22; G10L 15/26

(52) U.S. Cl. CPC G06F 40/20; G06F 3/0485; G10L 15/1815; G10L 15/22; G10L 15/26

(57) ABSTRACT

Described techniques may be utilized to receive a transcription stream including transcribed text that has been transcribed from speech, and to receive a summary request for a summary to be provided on a display of a device. Extracted text may be identified from the transcribed text and in response to the summary request. The extracted text may be processed using a summarization machine learning (ML) model to obtain a summary of the extracted text, and the summary may be displayed on the display of the device. When an image is captured, an augmented summary may be generated that includes the image together with a visual indication of one or more of an emotion, an entity, or an intent associated with the image, the summary, or the extracted text.

### CROSS REFERENCE TO RELATED APPLICATIONS

This application claims the benefit of U.S. Provisional Application No. 63/364,478, filed May 10, 2022, the disclosure of which is incorporated herein by reference in its entirety.

This application also incorporates by reference herein the disclosures to related co-pending applications, U.S. application Ser. No. 18/315,113, filed May 10, 2023, “Multi-Stage Summarization for Customized, Contextual Summaries”, filed May 10, 2023 (Attorney Docket No. 0120-533WO1), “Dynamic Summary Adjustments for Live Summaries”, filed May 10, 2023 (Attorney Docket No. 0120-534WO1), “Summary Generation for Live Summaries with User and Device Customization”, filed May 10, 2023 (Attorney Docket No. 0120-535WO1), “Summarization with User Interface (UI) Stream Control and Actionable Information Extraction”, filed May 10, 2023 (Attorney Docket No. 0120-541WO1), and “Incremental Streaming for Live Summaries”, filed May 10, 2023 (Attorney Docket No. 0120-589WO1).

### TECHNICAL FIELD

This description relates to summarization using machine learning (ML) models.

### BACKGROUND

A volume of text, such as a document or an article, often includes content that is not useful to, or desired by, a consumer of the volume of text. Additionally, or alternatively, a user may not wish to devote time (or may not have sufficient time) to consuming an entirety of a volume of text.

Summarization generally refers to techniques for attempting to reduce a volume of text to obtain a reduced text volume that retains most information of the volume of text within a summary. Accordingly, a user may consume information in a more efficient and desirable manner. In order to enable the necessary processing of the text, the latter may be represented by electronic data (text data). For example, a ML model may be trained to input text and output a summary of the text.

### SUMMARY

Described techniques process input text data to reduce a data volume of the input text data and obtain output text data expressing a summary of content of the input text data. The obtained, reduced volume of the output text data may be conformed to a size of a display, so as to optimize a size of the output text data relative to the size of the display. Moreover, described techniques may accomplish such customized data volume reductions with reduced delay, compared to existing techniques and approaches.

In a general aspect, a computer program product is tangibly embodied on a non-transitory computer-readable storage medium and includes instructions that, when executed by at least one computing device, are configured to cause the at least one computing device to receive a transcription stream including transcribed text that has been transcribed from speech, receive a summary request for a summary to be provided on a display of a device, and identify, from the transcribed text and in response to the summary request, extracted text. The instructions, when executed by the at least one computing device, are configured to cause the at least one computing device to process the extracted text using a summarization machine learning (ML) model to obtain a summary of the extracted text, and display the summary on the display of the device.

According to another general aspect, a device includes at least one processor, at least one memory, at least one input device, and at least one display, wherein instructions stored using the at least one memory, when executed by the at least one processor, cause the device to receive a transcription stream including transcribed text that has been transcribed from speech, receive, via the input device, a summary request for a summary to be provided on the at least one display, identify, from the transcribed text and in response to the summary request, extracted text, process the extracted text using a summarization machine learning (ML) model to obtain a summary of the extracted text, and display the summary on the at least one display.

According to another general aspect, a method includes receiving a transcription stream including transcribed text that has been transcribed from speech, receiving a summary request for a summary to be provided on a display of a device, identifying, from the transcribed text and in response to the summary request, extracted text, processing the extracted text using a summarization machine learning (ML) model to obtain a summary of the extracted text, and displaying the summary on the display of the device.

According to another general aspect, a computer program product is tangibly embodied on a non-transitory computer-readable storage medium and includes instructions that, when executed by at least one computing device, are configured to cause the at least one computing device to receive a transcription stream including transcribed text that has been transcribed from speech and receive an image associated with receipt of the transcription stream. The instructions, when executed by the at least one computing device, are configured to cause the at least one computing device to process the transcription stream using a summarization machine learning (ML) model to obtain a summary stream, including processing the transcribed text to obtain a summary; combine the image and the summary to obtain an augmented summary, and display the augmented summary.

According to another general aspect, a device includes at least one processor, at least one memory, at least one input device, and at least one display, wherein instructions stored using the at least one memory, when executed by the at least one processor, cause the device to receive a transcription stream including transcribed text that has been transcribed from speech, receive an image associated with receipt of the transcription stream, process the transcription stream using a summarization machine learning (ML) model to obtain a summary stream, including processing the transcribed text to obtain a summary, combine the image and the summary to obtain an augmented summary, and display the augmented summary using the at least one display.

According to another general aspect, a method includes receiving a transcription stream including transcribed text that has been transcribed from speech, receiving an image associated with receipt of the transcription stream, processing the transcription stream using a summarization machine learning (ML) model to obtain a summary stream, including processing the transcribed text to obtain a summary, combining the image and the summary to obtain an augmented summary, and displaying the augmented summary.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for summary generation for live summaries with user and device customization.

FIG. 2 is a flowchart illustrating example operations of the system of FIG. 1.

FIG. 3 is a block diagram illustrating a more detailed example implementation of the system of FIG. 1.

FIG. 4 is a flowchart illustrating example operations corresponding to the example of FIG. 3.

FIG. 5 illustrates example display layouts for use in the example of FIGS. 3 and 4.

FIG. 6 illustrates an example summary selection process for use in the example of FIGS. 3 and 4.

FIG. 7 is a third person view of a user in an ambient computing environment.

FIGS. 8A and 8B illustrate front and rear views of an example implementation of a pair of smartglasses.

FIG. 9 is a block diagram of an alternate implementation of the system of FIG. 1 for visual augmentation of transcribed text.

FIG. 10 is a flowchart illustrating example operations of the system of FIG. 1.

FIG. 11 is a block diagram illustrating more detailed example implementations of the system of FIG. 9.

FIG. 12 is a flowchart illustrating example operations corresponding to the example of FIG. 11.

FIG. 13 illustrates a first example implementation of visual augmentation of transcribed text, using the implementation of FIG. 11.

FIG. 14 illustrates a second example implementation of visual augmentation of transcribed text, using the implementation of FIG. 11.

FIG. 15 illustrates an example screenshot in which a scroll bar is used to identify text for visual augmentation.

### DETAILED DESCRIPTION

Described systems and techniques enable customized summary generation during a live conversation between a speaker and a user. Input speech (audio data) received at a device during the live conversation may be transcribed and resulting transcribed text (text data) may be provided as captions using a display of the device (or of another device). In response to a summary request or other summary trigger, a most-recent portion of the transcribed text may be extracted and processed using at least one trained summarization model, or summarizer, to provide a summary of the speech.

Conventional summary generation uses text prompts to trigger summarization, such as “summarize the following text:”. In contrast, described techniques summarize speech-to-text results during live conversations, dialogs, or other interactions between a speaker and a user. For example, such live summarization may be triggered in response to a summary request received from a user, and/or based on speech content of a speaker, user interface constraints of a device/display used to provide the transcript/summary, as well as user preferences (e.g., as determined based on device settings chosen by a user or other operation of the device by a user) with respect to whether, when, and how a summary is generated. Such techniques enable reduced computation workloads as well as intelligent switching between live transcriptions and live summarizations.

In particular examples, augmented reality (AR) glasses and Virtual Reality (VR) headsets with video-see-through capabilities are becoming increasingly popular. Such devices offer a number of advantages over traditional smartphones and tablets, including, e.g., hands-free access to information and the ability to overlay digital content (e.g., real-time captions) in the real world. However, one of the main challenges with such devices is that the field of view is often limited (e.g., within 20 degrees field of view to ensure an all-day-use battery life), constraining how much text can reasonably be rendered onto a corresponding display.

The types of adaptive summarization of speech described herein help to address problems and difficulties with limited resolutions/displays, e.g., by reducing an amount of data to be transmitted to AR glasses from a paired device (e.g., smartphone). As described in detail, below, such reductions in transmitted data volume may be obtained by automatically summarizing key points of a conversation using a Transformer based language model(s), or by compressing the audio file itself.

As a result, such AR/VR devices may be more comfortable to wear for longer periods of time, and battery life of the device(s) may be improved. Reducing the amount of data that needs to be transmitted not only has the potential to improve the battery life of the device, but also provides new opportunities for personalizing the experience for each user, with the potential to make AR glasses more comfortable, user-friendly, and accurate. For example, a volume of the audio may be dynamically adjusted, and/or certain keywords or phrases may be highlighted.

Described techniques provide methods to adaptively summarize and compress speech, e.g., in response to a summary request received from a user, and/or in response to some other summarization trigger(s). For example, a summary request may be received manually from a user via a hardware input device, such as a touchscreen or capacitive touch user interface, a physical button, a hand or head gesture, or other input suitable to a form factor of a device being used. In other examples, a summary request may be received verbally, such as a statement of the word “summarize” by the user.

Additionally, or alternatively, summary triggers may be detected based on speech characteristics of the speech being analyzed. For example, speech containing a defined number of words (e.g., within a specified time interval), such as 200 words, may be automatically summarized, while speech with a number of words below the defined number may not be summarized (unless requested by a user). In further examples, speech with a number of words below a minimum number (e.g., 30 words) may not be summarized even if a summary request is received from a user, if the transcribed speech may be suitably displayed without summarization.

As referenced above, the relevant speech characteristics may be expressed as a rate of speech (e.g., number of words per second, or per minute), rather than as a number of words. Other criteria may be used, as well, such as using a detected pause of sufficient length (e.g., 2 seconds) within the speech as a summary trigger. Combinations of such summary triggers may also be used, as well as, as referenced above, considerations related to a resolution/size of a relevant display and/or user preferences for whether/when/how to receive summaries. Further, over time, user selections and actions may be used to fine-tune the summarization model being used, so that the user receives summaries in a personalized and customized manner.

A wearer or other user may be provided with an ability to explicitly choose between summary and transcription modes. For example, a user may toggle between transcription and summary modes. In other examples, a user may be provided with summaries, and with an ability to switch back to a transcription mode if the summaries are not satisfactory to the user.

In specific examples related to AR/VR glasses having a defined field of view (FOV), e.g., 100° FOV, summarization may be rendered in a peripheral vision of the wearer by default, but may be moved towards a center of the field of view (e.g., the fovea) when the summaries are determined to be important (e.g., as determined using the example techniques referenced above).

Consequently, described techniques may be used to leverage adaptive summarization and compression of speech on AR/VR glasses and other devices, with display technologies including but not limited to all head-mounted displays (HMDs), wearables (e.g., watches, fitness bands/trackers), and other computing devices (e.g., smartphone, laptop, or desktop computers).

In addition to addressing the issues of limited resolution/display in the system as referenced above, described summarization techniques may be used to address other challenges with real-time conversation. For example, adding summarizations to daily conversations and other live interactions may provide many potential benefits.

For example, such summarizations may reinforce speaker statements, while improving issues with speech redundancy and poor articulation (e.g., filler words, stutters, and the like). In other examples, summarization techniques may assist in understanding fast-moving conversations (e.g., fast-paced speakers) by reducing an amount of information presented at a time. In other examples, described techniques may assist users in remembering the main points of lengthy speech and otherwise tracking a status and/or overview of a conversation (including note-taking in the context of a lecture), even when the speech includes various digressions with respect to a primary topic being discussed. Consequently, a user may be assisted in following a conversation or other dialog.

Thus, a user may be provided with, e.g., a summary stream of captions that are updated as a speaker speaks. Then, described techniques may utilize user preferences of the user, speech characteristics of the speaker, and/or device characteristics of the device to dynamically adjust summary characteristics of the summary stream over time and during the live conversation. Accordingly, a user may have a fluid experience of the live conversation, in which the dynamically adapted summary stream assists the user in understanding the live conversation.

Consequently, described techniques may be helpful, for example, when a user is deaf or heard of hearing, as the user may be provided with the summary stream visually on a display. Similarly, when the user is attempting to converse with a speaker in a foreign language, the user may be provided with the summary stream in the user's native language.

Described techniques may be implemented for virtually any type of spoken input text (text data). For example, automatic speech recognition (ASR), or other transcription techniques, may be used to provide a live transcription of detected speech, which may then be provided or available to a user as a transcription stream. Then, described techniques may be used to simultaneously provide the type of live, dynamically adjusted summarization stream referenced above, i.e., to provide the summarization stream in parallel with the transcription stream.

For example, a user wearing smartglasses or a smartwatch, or using a smartphone, may be provided with either/both a transcription stream and a summarization stream while listening to a speaker. In other examples, a user watching a video or participating in a video conference may be provided with either/both a transcription stream and a summarization stream.

Described techniques thus overcome various shortcomings and deficiencies of existing summarization techniques, while also enabling new implementations and use cases. For example, existing summarization techniques may reduce input text excessively, may not reduce input text enough, may include irrelevant text, or may include inaccurate information. In scenarios referenced above, in which a transcription stream and a summarization stream are desired to be provided in parallel, existing summarization techniques (in addition to the shortcomings just mentioned) may be unable to generate a desirable summary quickly enough, or may attempt to generate summaries at inopportune times (e.g., before a speaker has finished discussing a topic). Still further, existing techniques may generate a summary that is too lengthy (or otherwise maladapted) to be displayed effectively on an available display area of a device being used (e.g., smartglasses).

In contrast, described techniques solve the above problems, and other problems, by, e.g., analyzing spoken input while accessing user preferences and device characteristics over a period(s) of time during a live conversation. Consequently, described techniques are well-suited to generate dynamic, real-time summaries that are adapted over time during the course of one or more live conversations, while a speaker is speaking, and in conjunction with a live transcription that is also produced and available to a user.

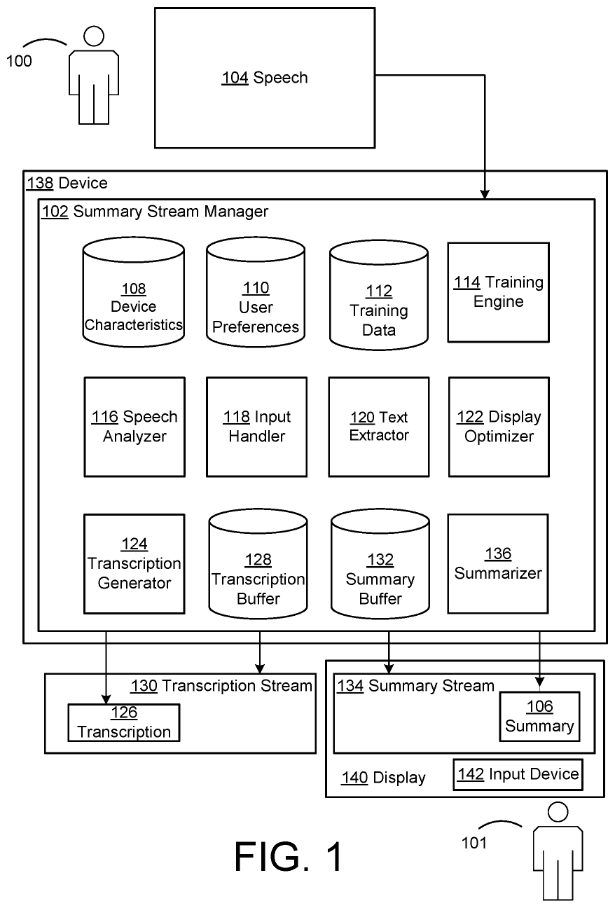

FIG. 1 is a block diagram of a system for summary generation for live summaries with user and device customization. In the example of FIG. 1, a summary stream manager 102 processes speech 104 (audio data, also referred to as spoken input) of a speaker 100 to obtain a summary 106 that is provided to a user 101 as part of a live, dynamically adjusted summary stream 134 (a data stream). As referenced above, the speech 104 may include virtually any spoken words or other spoken input. For example, the speech 104 may be a lecture, a talk, a dialogue, an interview, a conversation, or any other spoken-word interaction of two or more participants. Such interactions may be largely one-sided (a monologue), such as in the case of a lecture, or may be an equal give-and-take between the speaker 100 and the user 101.

For example, a conversation may be conducted between the speaker 100 and the user 101, and the conversation may be facilitated by the summary stream manager 102. As just noted, in other examples, the speaker 100 may represent a lecturer, while the user 101 represents a lecture attendee, so that the summary stream manager 102 facilitates a utility of the lecture to the user 101. The speaker 100 and the user 101 may be co-located and conducting an in-person conversation, or may be remote from one another and communicating via web conference.

In other examples, the speaker 100 may record the speech 104 at a first time, and the user 101 may view (and receive the summary 106 of) the recorded audio and/or video at a later time. In this sense, the term ‘live conversation’ should be understood to be primarily from the perspective of the user 101. For example, as just noted, the user 101 may listen live to a video of the speaker 100 that was previously recorded, and be provided with the type of live summary stream 134 described herein.

FIG. 1 should thus be understood to illustrate an ability of the summary stream manager 102 to provide the summary 106 in a stand-alone or static manner, in response to a discrete instance of the speech 104 (e.g., summarizing audio of a single recorded video). At the same time, FIG. 1 also illustrates an ability of the summary stream manager 102 to receive speech of the speaker 100 over a first time interval and output the summary 106 to the user 101, and then to repeat such speech-to-summary operations over a second and subsequent time interval(s) to provide the types of dynamic summarizations referenced above, and described in detail below with reference to the summary stream 134. In other words, as shown and described, the summary 106 may be understood to represent a single discrete summary of corresponding discrete speech of the speaker 100 within a single time interval of a larger time period or time window of a conversation.

As also described in detail, below, the summary stream manager 102 may be implemented in conjunction with any suitable device 138, such as a handheld computing device, smartglasses, earbuds, or smartwatch. For example, the summary stream manager 102 may be implemented in conjunction with one or more such devices in which a microphone or other input device is used to receive the speech 104, and an audio output, visual display (e.g., a display 140 in FIG. 1), and/or other output device(s) is used to render or provide the summary 106 and the summary stream 134.

The summary stream manager 102 is illustrated in the simplified example of FIG. 1 as a single component that includes multiple sub-components. As also described below, however, the summary stream manager 102 may be implemented using multiple devices in communication with one another.

As shown in FIG. 1, the summary stream manager 102 may include or utilize device characteristics 108 of the one or more devices represented by the device 138 in FIG. 1. For example, device characteristics may include a display size of the display 140, available fonts or formats, or available scroll rates of the device 138/display 140.

User preferences 110 may include any user preference for receiving the summary stream 134 (e.g., as reflected by device settings chosen by a user or by other operation of the device by a user). For example, the user preferences 110 may include a user preference for a slow, medium, or fast scroll rate of the summary stream 134 on the display 140. The user preferences 110 may also specify preferred fonts/formats, or preferred device(s) among a plurality of available devices. The user preferences 110 may be input manually by the user 101, and/or inferred by the summary stream manager 102 based on actions of the user 101.

Training data 112 generally represents any training data that may be processed by a training engine 114 to train one or more machine learning (ML) models, as described herein. The training data 112 may represent one or more available repositories of labeled training data used to train such ML models, and/or may represent training data compiled by a designer of the summary stream manager 102.

A speech analyzer 116 may be configured to receive the speech 104, e.g., via a microphone or other input of the device 138, and process the speech 104 to determine relevant speech characteristics (as reflected by the audio data representing the speech). For example, the speech analyzer 116 may calculate or otherwise determine a rate, a tonality, a volume, a pitch, an emphasis, or any other characteristic of the speech 104. The speech analyzer 116 also may identify the speaker 100 individually or as a class/type of speaker. For example, the speech analyzer 116 may identify the speaker 100 as a friend of the user 101, or as a work colleague or teacher of the user 101. The speech analyzer 116 may also identify a language being spoken by the speaker 100.

An input handler 118 may be configured to receive or identify any of the user preferences 110 discussed above, as well as to receive summary requests from the user 101, as described in detail, below. For example, the input handler 118 may provide for interactivity with the user 101, e.g., via the display 140, to receive manually-submitted preferences and summary requests. Such manually submitted preferences or summary requests may be received from an input device 142 associated with the display 140 and/or the device 138, where the input device 142 may include, e.g., a touchscreen, a scroll bar, a button, a switch, a microphone, a gesture detector, or any other suitable input device(s), or combinations thereof. The input handler 118 may be implemented using heuristics, or may be implemented as a trained ML model that is trained using the training engine 114.

A text extractor 120 may be configured to extract transcribed text to be summarized, e.g., from a transcription stream 130 as described in detail, below. For example, in response to a summary request received via the input device 142 and the input handler 118, the text extractor 120 may extract most-recent transcribed text from the transcription stream 130. For example, the text extractor 120 may retrieve a most-recent ten seconds, or five seconds, or other suitable time interval, of the transcription stream 130. In other examples, the text extractor 120 may retrieve transcribed text based on detected characteristics of the transcription stream 130, such as detected pauses and/or punctuation within the transcribed speech. The text extractor 120 may be implemented using heuristics, or may be implemented as a trained ML model that is trained using the training engine 114.

A display optimizer 122 may be configured to optimize use of the display 140 in generating and displaying the transcription stream 130 and/or the summary stream 134. For example, the display optimizer 122 may be used to conform the summary 106 for display using the display 140, so that, e.g., the summary 106 is neither too small nor too big for the display 140. The display optimizer 122 may be implemented using heuristics, or may be implemented as a trained ML model that is trained using the training engine 114.

A transcription generator 124 may be configured to convert the spoken words of the speech 104 to transcribed text, shown in FIG. 1 as a transcription 126. For example, the transcription generator 124 may include an automatic speech recognition (ASR) engine or a speech-to-text (STT) engine.

The transcription generator 124 may include many different approaches to generating text, including additional processing of the generated text. For example, the transcription generator 124 may provide timestamps for generated text, a confidence level in generated text, and inferred punctuation of the generated text. For example, the transcription generator 124 may also utilize natural language understanding (NLU) and/or natural language processing (NLP) models, or related techniques, to identify semantic information (e.g., sentences or phrases), identify a topic, or otherwise provide metadata for the generated text.

The transcription generator 124 may provide various other types of information in conjunction with transcribed text, perhaps utilizing related hardware/software. For example, the transcription generator 124 may analyze an input audio stream to distinguish between different speakers, or to characterize a duration, pitch, speed, or volume of input audio, or other audio characteristics. For example, in some implementations, the transcription generator 124 may be understood to implement some or all of the speech analyzer 116.

In FIG. 1, the transcription generator 124 may utilize a transcription buffer 128 to output the transcription stream 130. That is, for example, the transcription generator 124 may process a live conversation, discussion, or other speech, in real time and while the speech is happening. The transcription 126 thus represents a transcription of a segment or instance of transcribed text within a time interval that occurs within a larger time period or time window of a conversation. For example, the summary 106 may represent a summarization of the transcription 126, where the transcription 126 represents a transcript of, e.g., a first 10 seconds of the speech 104.

For example, while the speaker 100 is speaking, the transcription generator 124 may output transcribed text to be stored in the transcription buffer 128. The transcribed text may be designated as intermediate or final text within the transcription buffer 128, before being available as the transcription 126/transcription stream 130. For example, the transcription generator 124 may detect the end of a sentence, a switch in speakers, a pause of pre-defined length, or other detected audio characteristic to designate a final transcription to be included in the transcription stream 130. In other examples, the transcription generator 124 may wait until the end of a defined or detected time interval to designate a final transcription of audio.

The transcription stream 130 may thus be processed by a summarizer 136, e.g., in response to a summary request received from the input handler 118, to populate a summary buffer 132 and otherwise output the summary 106/summary stream 134. Although the transcription buffer 128 and the summary buffer 132 are described herein as memories used to provide short-term storage of, respectively, the transcription stream 130 and the summary stream 134, it will be appreciated that the same or other suitable memory may be used for longer-term storage of some or all of the transcription stream 130 and the summary stream 134. For example, the user 101 may wish to capture a summary of a lecture that the user 101 attends for later review.

The summarizer 136 may represent any trained model or algorithm designed to perform summarization. For example, the summarizer 136 may be implemented as a sequence-to-sequence generative large learning model (LLM).

As noted above, the summarizer 136 may be invoked in response to a summary request received via the input handler 118 (e.g., from the input device 142). Over time, the summarizer 136 may be fine-tuned to predict a need or desire for the summary 106 for the user 101, based on earlier selections or actions of the user 101. For example, the summarizer 136 may be fine-tuned to relate characteristics of the transcription stream 130 at a time of one or more previous summary requests to determine whether to generate the summary 106 at a current time. For example, the text extractor 120 and/or the summarizer 136 may detect sentence endings, pauses in speech, or a rate (or other characteristic) of the audio to determine whether/when to invoke the summarizer 136.

For example, the text extractor 120 may be configured to analyze selections made or actions taken by the user 101 with respect to the transcription stream 130 and/or the summary stream 134, in order to determine or infer user preferences 110 for whether and when to invoke a summarization by the summarizer 136. For example, the input handler 118 may detect that the user 101 frequently requests a summary in corresponding scenarios or contexts, and may update the user preferences 110 to reflect a higher likelihood of generating a summary in such scenarios/contexts going forward.

In some examples, upon receipt of a summary request via the input device 142, the text extractor 120 may extract text from the transcription stream 130, such as the transcription 126, from a time either before and/or after a time of the summary request. For example, if the summary request is received at time t=0, the transcription 126 may include text from a time t=−10 (i.e., a preceding 10 seconds), and/or text from a time t=10 (i.e., a subsequent 10 seconds). For example, transcription text from prior to the summary request may be obtained from the transcription buffer 128.

In further examples, the display optimizer 122 may be configured to control various display characteristics with which the transcription stream 130 and/or the summary stream 134 are provided. For example, the display optimizer 122 may provide the user 101 with an option to view either or both (e.g., toggle between) the transcription stream 130 and the summary stream 134.

The display optimizer 122 may also be configured to display various indicators related to the transcription stream 130 and the summary stream 134. For example, the display optimizer 122 may display a summarization indicator that informs the user 101 that a current portion of the summary stream 134 is being generated, while the summarizer 136 is processing a corresponding portion of the transcription stream 130. As referenced above, the display optimizer 122 may also control a size, spacing, font, format, and/or speed (e.g., scrolling speed) of the transcription stream 130 and the summary stream 134.

In the following description, a compression ratio refers to a measure of an extent to which the summary 106 is reduced with respect to corresponding input speech of the speech 104. For example, in a simple example, if the summary 106 includes 50 words and is generated from speech 104 that includes 100 words, the corresponding compression ratio would be 50% or 0.5. A compression ratio may be calculated using various techniques in addition to, or instead of, word count. For example, a compression ratio may be expressed as a character count rather than a word count, or may be implemented as a word count but excluding stop words.

The summarizer 136 may be configured to implement a suitable compression ratio, directly or indirectly, to ensure that the summary 106, and the summary stream 134 in general, conforms to the requirements of, e.g., the input handler 118, the text extractor 120, and the display optimizer 122. For example, the text extractor 120 may extract a quantity of text for summarization, and the display optimizer 122 may require that the resulting summary includes a maximum of 4 lines of 5 words each in order to be suitably displayed using the display 140. Then, the summarizer 136 may utilize a suitable compression ratio to ensure that the extracted text is summarized accordingly.

Additionally, the stream manager 102 may provide additional processing of the summary stream 134. For example, the stream manager 102 may identify and extract actionable content within the summary stream 134, such as calendar items, emails, or phone calls. In some implementations, the stream manager 102 may be configured to facilitate or enact corresponding actions, such as generating a calendar item, or sending an email or text message, based on content of the summary stream 134.

In FIG. 1, the transcription stream 130 is shown separately from the summary stream 134, and from the display 140. However, as noted above, the transcription stream 130 may be displayed on the display concurrently with, or instead of, the summary stream 134. Moreover, the transcription stream 130 and the summary stream 134 may be implemented as a single (e.g., interwoven) stream of captions. That is, for example, the transcription stream 130 may be displayed for a period of time, and then a summary request may be received via the input device 142, and a corresponding summary (e.g., the summary 106) may be generated and displayed. Put another way, an output stream of the display 140 may alternate between displaying the transcription stream 130 and the summary stream 134.

In the simplified example of the stream manager 102, the various sub-components 108-136 are each illustrated in the singular, but should be understood to represent at least one instance of each sub-component. For example, two or more training engines, represented by the training engine 114, may be used to implement the various types of training used to train and deploy various ML models used in or with the summary stream manager 102.

In FIG. 1, the summary stream manager 102 is illustrated as being implemented and executed using the device 138. For example, the device 138 may represent a handheld computing device, such as a smartphone, or a wearable computing device, such as smartglasses, smart earbuds, or a smartwatch.

The device 138 may also represent cloud or network resources in communication with a local device, such as one or more of the devices just referenced. For example, the various types of training data and the training engine 114 may be implemented remotely from the user 101 operating a local device, while a remainder of the illustrated components of the summarization manager are implemented at one or more of the local devices.

The summary 106 and/or the summary stream 134 are illustrated as being output to the display 140. For example, the display 140 may be a display of the device 138, or may represent a display of a separate device(s) that is in communication with the device 138. For example, the device 138 may represent a smartphone, and the display 140 may be a display of the smartphone itself, or of smartglasses or a smartwatch worn by the user 101 and in wireless communication with the device 138.

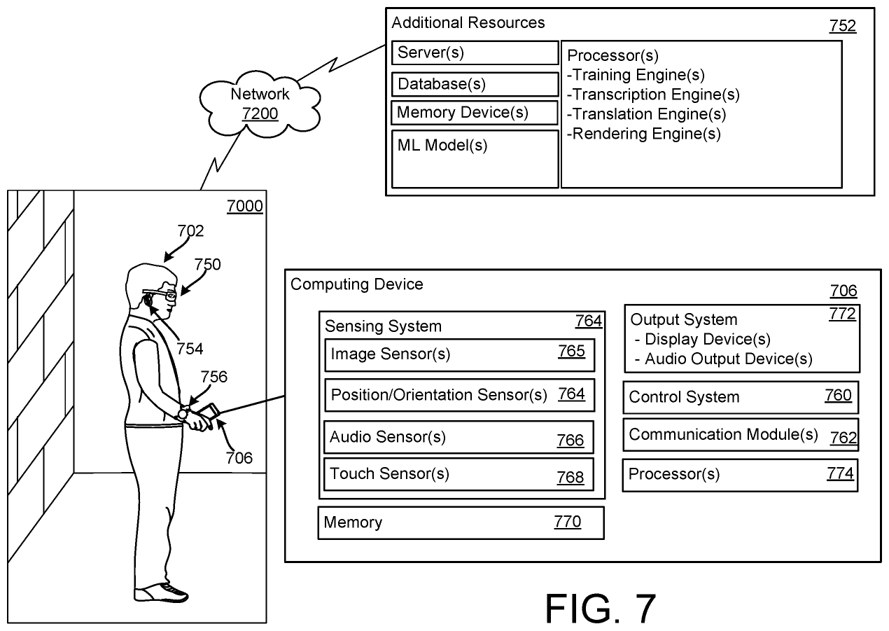

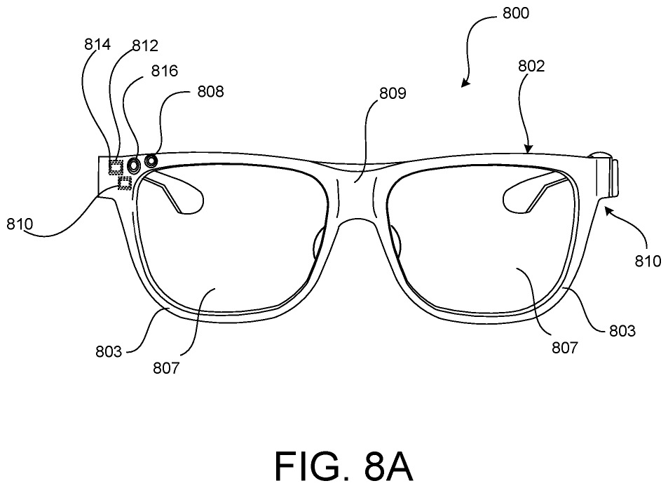

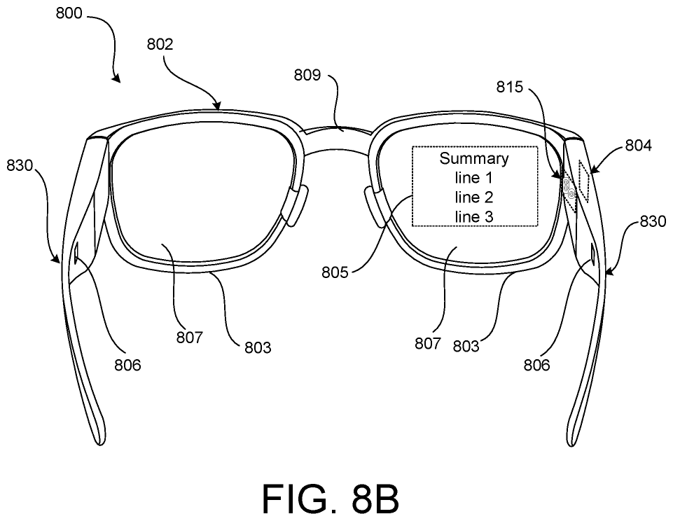

More detailed examples of devices, displays, and network architectures are provided below, e.g., with respect to FIGS. 7, 8A, and 8B. In addition, the summary 106 and the summary stream 134 (as well as the transcription 126 and the transcription stream 130) may be output via audio, e.g., using the types of smart earbuds referenced above.

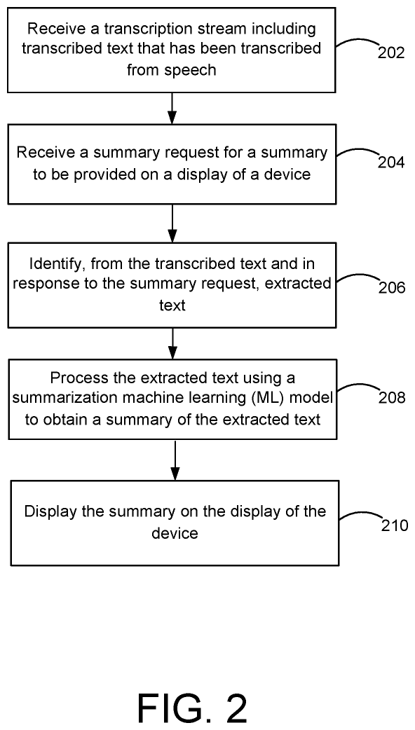

FIG. 2 is a flowchart illustrating example operations of the system of FIG. 1. In the example of FIG. 2, operations 202-210 are illustrated as separate, sequential operations. However, in various example implementations, the operations 202-210 may be implemented in a different order than illustrated, in an overlapping or parallel manner, and/or in a nested, iterative, looped, or branched fashion. Further, various operations or sub-operations may be included, omitted, or substituted.

In FIG. 2, the transcription stream 130 may be received that includes transcribed text (text data, e.g., transcription 126) that has been transcribed from the speech 104 (audio data) (202). For example, as described herein, the transcription stream 130 (a data stream) may be received from an ASR engine or any other example of the transcription generator 124. The transcription stream 130 may be received at a HMD and displayed on a display of such a HMD, as represented by the device 138 and the display 140 of FIG. 1. For example, the transcription stream 130 may be displayed on the display 140 as streaming captions that capture the speech 104 for consumption by the user 101. In other examples, the transcription stream 130 may be captured in a background process, and is not required to be displayed.

A summary request may be received for a summary to be provided on a display of a device (204). For example, a summary request may be received from the user 101 via the input device 142, which is associated with the display 140 in FIG. 1, but may also be associated with the device 138 when the device 138 is separate from (e.g., in wireless communication with) the display 140. As described herein, the input device 142 may represent, e.g., a gesture recognition detector, a slide wheel, a touchscreen, a microphone, or a mouse, so that any suitable input functionality for capturing a summary request may be used, including, e.g., a tap, a gesture, a nod, a click, a spoken or vocal command, or a touch. For example, the user 101 may be listening to the speaker 100, and may feel that information has been missed from within the speech 104, or that upcoming speech is likely to be missed (e.g., if the speaker 100 is speaking very quickly, at a relatively low volume, or in a different language).

As described herein, summaries may be initiated by the user 101, and/or by the summary stream manager 102 in response to, e.g., detected characteristics of the speech 104, perhaps with reference to the user preferences 110 and/or the device characteristics 108. Such speech characteristics may include, e.g., a rate or volume of the speech 104, or in response to a pause in the speech 104 by the speaker 100, or in response to punctuation detected by the transcription generator 124.

For example, the summary stream manager 102 may determine and update automatic summary requests over time, as the user 101 uses the summary stream manager 102. For example, if the user 101 frequently requests a summary in certain situations, such as the types of fast speech referenced above, the summarizer 136 may be fine-tuned to recognize such rates of speech in the future and automatically initiate summary generation.

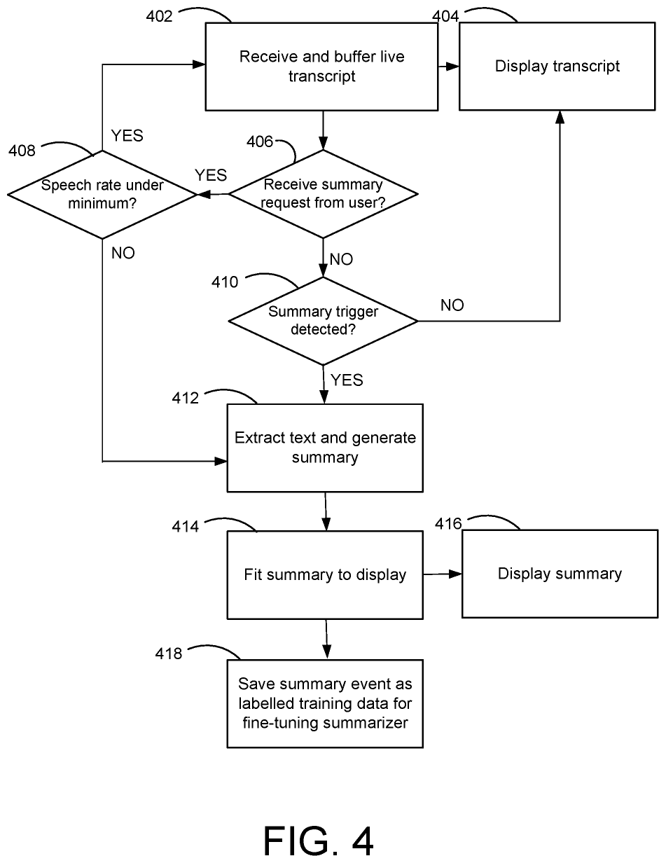

From the transcribed text and in response to the summary request, extracted text may be identified (206). For example, the transcription 126 may be extracted from the transcription stream 130. In some examples, the transcription 126 may be obtained from the transcription buffer 128, including transcribed text that may have been buffered prior to receipt of the summary request. In other examples, the transcription 126 may be captured after the summary request is received. Put another way, if the summary request is received at a time t=0, the extracted text may include transcribed text that occurred prior to t=0 and was buffered in the transcription buffer 128 and/or may include transcribed text that occurred after t=0 and that was identified for summarization in conjunction with text transcription operations. Additional example extraction operations for obtaining the extracted text are described in more detail, below, e.g., with respect to FIG. 4.

The extracted text may be processed using a summarization machine learning (ML) model to obtain a summary of the extracted text (208). For example, the summarizer 136 may process the transcription 126 to output the summary 106. The summary may be displayed on the display 140 of the (same or separate) device 138 (210).

In example implementations, the summarizer 136 may provide the summary stream 134 with the summary 106, which may be displayed in parallel with, or alternated with, the transcription stream 130. In other words, for example, the user 101 has the ability to view the transcription stream 130 with one or more summaries of the summary stream 134 interspersed therein, as desired by the or may toggle between the transcription stream 130 and the summary stream 134.

Many different display techniques may be used, some of which are described herein. For example, the summary 106 may be truncated or otherwise processed to fit the display 140 in a desired manner, e.g., based on the device characteristics 108 and the user preferences 110.

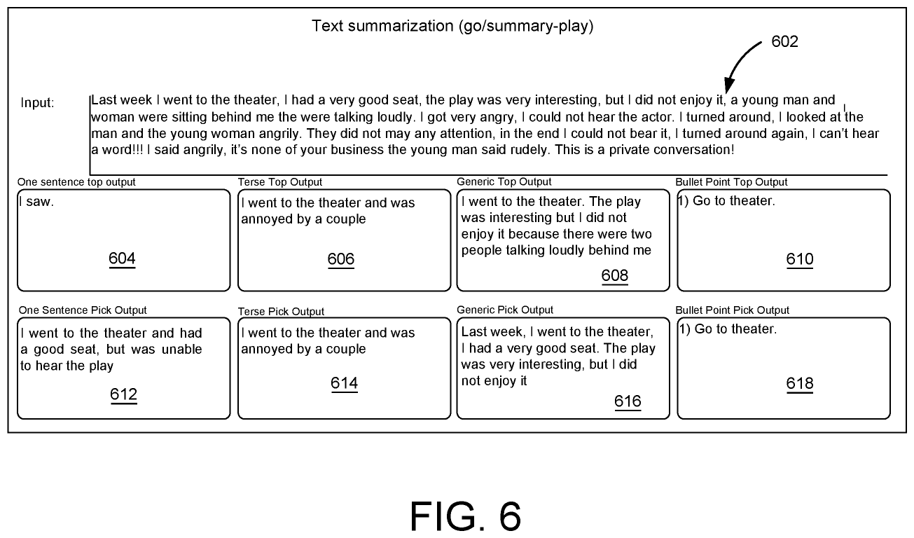

In other examples, other display-sizing techniques may be used. For example, the summarizer 136 may be provided with summary size constraints, such as a minimum and/or maximum number of words to be included in the summary 106, so that the provided summary 106 can make optimal use of an available screen size of the display 140. In some implementations, as described with respect to FIG. 6, the summarizer 136 may generate multiple summaries, and a best-available summary may be selected as the summary 106, e.g., based on the device characteristics 108 and the user preferences 110.

Other example display techniques may be used, as well. For example, in the context of an HMD such as the smartglasses of FIG. 8A and FIG. 8B, the summary 106 may be provided at a periphery of available screen size, unless some other display parameter specifies that the summary 106 should be moved to be displayed at a central display portion.

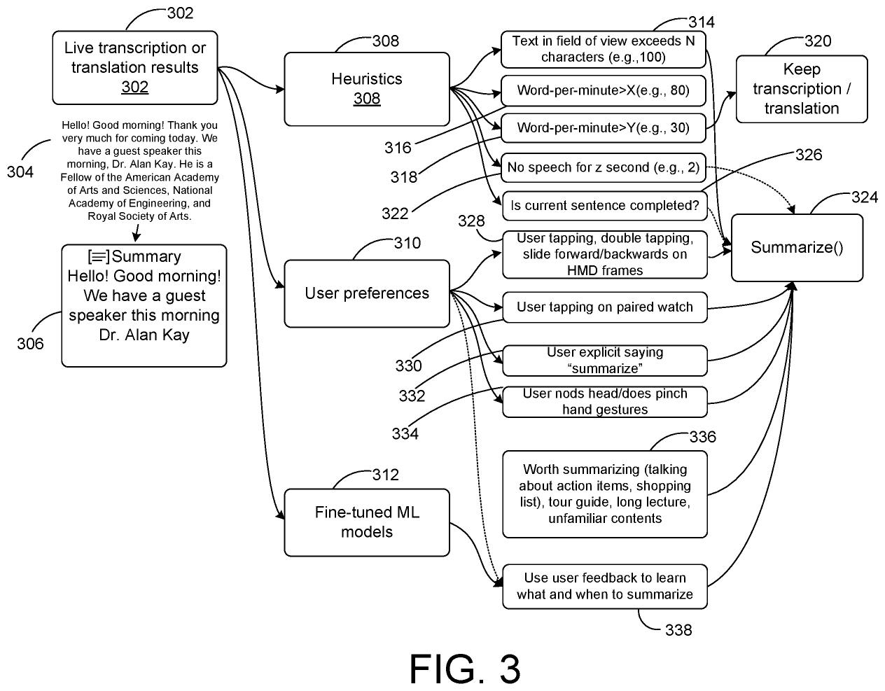

FIG. 3 is a block diagram illustrating a more detailed example implementation of the system of FIG. 1. In the example of FIG. 3, live transcription/translation results 302 may be received. For the sake of illustration, a transcription example 304 is provided as “Hello! Good morning! Thank you very much for coming today. We have a guest speaker this morning, Dr. Alan Kay. He is a Fellow of the American Academy of Arts and Sciences, National Academy of Engineering, and Royal Society of Arts,” which is shown as being summarized in a summary 306 that includes a summary “Hello! Good morning! We have a guest speaker this morning, Dr. Alan Kay.”

FIG. 3 illustrates that the summary 306 may be triggered using heuristics 308, user preferences 310, or fine-tuned ML model(s) 312. For example, with respect to heuristics 308, the summary 306 may be generated in response to a first heuristic 314, defined as triggering summarization 324 when a quantity of text within a field of view of a display used to provide the transcription/translation results 302 exceeds a certain character count of N characters (e.g., 100 characters). The summary 306 may be generated in response to a second heuristic 316, defined as triggering summarization 324 when a word-per-minute rate exceeds a certain value X (e.g., 80 words-per-minute).

In response to a third heuristic 318, when a word-per-minute is less than a defined value Y (e.g., 30 words-per-minute), the transcription/translation 320 may be retained. In other words, for example, even if a user requests a summary, the system of FIG. 3 may retain transcription/translation results according to the third heuristic 318. For example, if a speaker is speaking slowly, there may be no benefit to attempting to summarize, and/or there may be potential for needlessly losing information in such a summary.

The summary 306 may be generated in response to a fourth heuristic 322, defined as triggering summarization 324 when there is no speech (e.g., a pause) for at least a certain number of seconds Z (e.g., 2 seconds). The summary 306 may be generated in response to a fifth heuristic 326, defined as triggering summarization 324 when a current sentence is determined to be completed.

With respect to user preferences 310, summarization 324 may be triggered in response to a user action 328 taken with respect to a HMD being worn, such as tapping, double tapping, or sliding forward/backwards on a sensor or scroll bar on HMD frames. Similarly, a user action 330 of tapping on a smartwatch paired with a HMD may trigger summarization 324. A user action 332 of verbally providing a ‘summarize’ command may trigger summarization 324. Additionally, user action 334 of using a head gesture (e.g., nodding) or a pinch hand gesture functionality of a HMD may trigger summarization 324.

When using fine-tuned ML models 312, user feedback 338 (e.g., the user preferences 310) may be used to learn what and when to provide summarization 324. For example, once such fine-tuning has been done, automatically-recognized triggers 336 may be used to trigger summarization 324, e.g., topics that are considered worth summarizing based on the fine-tuning, including talking about action items, shopping lists, comments from a tour guide, a long lecture, or content that is determined to be unfamiliar to the user 101.

FIG. 4 is a flowchart illustrating example operations corresponding to the example of FIG. 3. In the example of FIG. 4, a live transcription may be received and buffered (402). In some implementations, the resulting transcription may be automatically or preferentially displayed (404).

If a summary request is received from a user (406), then, if a corresponding speech rate is below a minimum (408), transcription may continue without summarizing (402). Otherwise, corresponding text may be extracted from the transcript and summarized (412).

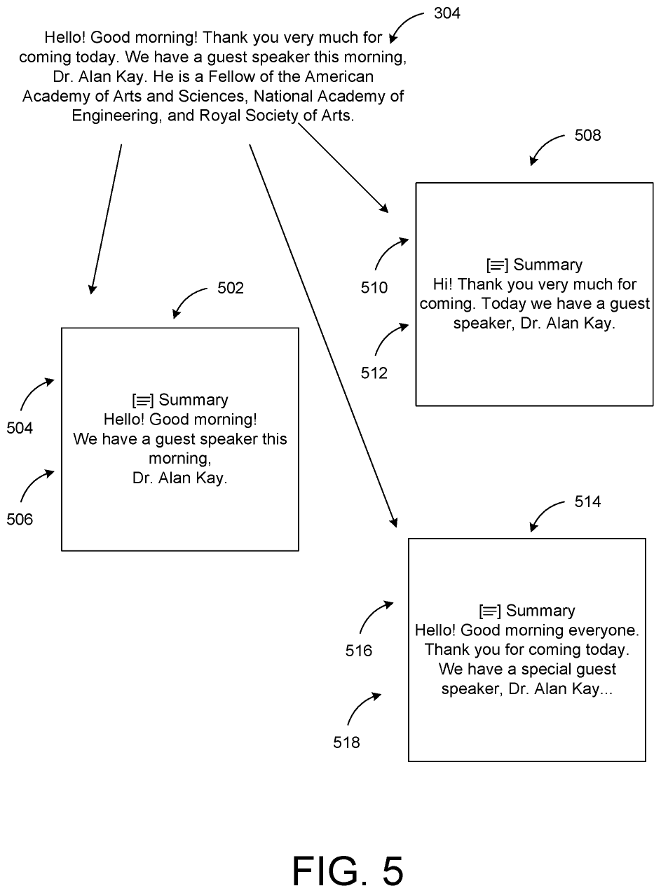

The resulting summary may be fit to a relevant display or screen (414) and displayed (416). For example, FIGS. 5 and 6 illustrate various examples illustrating truncating a summary and/or generating a summary of appropriate size to enable fitting of the summary to a relevant display. FIG. 8B illustrates an explicit example of displaying a summary using a HMD.

A summary event may be stored that includes at least the summary and the corresponding summary request as labeled training data, perhaps in conjunction with any other suitable metadata that may be useful to include in labeled training data (418). For example, a summary context or type may be stored, or a response of the user 101 (e.g., reviewing the summary or deleting the summary) may be captured. Accordingly, the summarizer 136 may be fine-tuned using resulting labeled training data. Accordingly, for example, a future summary request may be received that does not require a user action of the user 101 to trigger the summary, and corresponding extracted transcription text may be extracted and summarized using the fine-tune summarizer 136.

As described herein, extraction of transcribed text for summarization may be executed with respect to a time t=0 at which the summary request is received (406) or some other summary trigger (as described above with respect to heuristics 308) is detected (410). For example, extraction may capture t-10 seconds of preceding text from the transcription buffer 128, or may extract text up until a most-recent period (or other punctuation) or pause. In other examples, extraction may occur with respect to current/future transcribed text, such as when a summary request triggers summarization of a subsequent 10 seconds (t+10), or of a subsequent sentence, or number of sentences.

Such extraction parameters may be predefined and stored using the user preferences 110, and/or may be determined with respect to fine-tuning of the summarizer 136. In other examples, multiple extraction options may be available to the user 101. For example, when using a HMD with a sensor or scroll bar, the user 101 may slide/scroll the bar forward to summarize subsequently-received transcription(s), and may slide/scroll the bar backwards to summarize previously-received transcription(s) from the transcription buffer 128.

As noted above, extraction parameters may be determined using labeled training data. For example, a label may be determined in the format of “<Previous Sentence>→<Should [NOT] summarize> in <sentences>/<bullet points>”. A fixed separator “→”, informs the model when the prompt ends and the completion begins. A fixed stop sequence, e.g., “\n”, may be used to indicate a completion of a current example.

For example, such training data may be generated as:

{“prompt”: “<Previous Sentences> →”,
“completion”:
“<Should not summarize>”;
“<Should summarize> in two sentences”;
“<Should summarize> in one sentence”;
“<Should summarize> as bullet points”;
“<Should summarize> as bullet points, with no more than five key items;”
...
\n”}

Human annotators may be employed to label an appropriate starting sentence and ending sentence. Resulting few-shot training data may then be fed into the relevant models to finetune the model(s) to output summaries.

Additionally, or alternatively, timestamp(s) may be added when a summarization(s) is triggered. Then, following conversations may be fed into the model to generate summaries, with more-recent sentences emphasized by the model. For example, timestamps may be added every 10 seconds into raw input data, which will enable the fine-tuned LLM models to learn how to emphasize more recent sentences and determine the types of labels referenced above, or a similar labelling scheme.

During the types of training referenced above, when errors occur between a generated summary as compared to a ground truth summary of the labeled training data, a type and/or degree of the error may be used by the training engine 114 in a subsequent training iteration to adjust weights or other parameters of the summarizer 136. Over multiple iterations, the weights or other parameters may thus be adjusted by the training engine 114 to cause the summarizer 136, once deployed, to process the speech 104 and generate a corresponding summary in a desired fashion.

In more specific example implementations, described example techniques enable modeling user preferences/actions, device characteristics, and speech characteristics into intermediate representations, and then using such intermediate representations as additional inputs along with a raw ASR transcript to produce useful and usable summaries. For example, as illustrated in more detail, below, with respect to FIG. 6, described techniques enable dynamically controlling summarization to be more or less terse, based at least on the aforementioned factors, or similar suitable factors.

FIG. 5 illustrates example display layouts for use in the example of FIGS. 3 and 4, with respect to the example transcript 304 of FIG. 3. In the example of FIG. 5, a first screenshot 502 includes a header portion 504 and a body portion 506. As shown, the header portion 504 may be used to display one or more icons and/or related meta information or metadata, while the body portion 506 may include a summary of the example transcript 304. FIG. 5 further illustrates a second screenshot 508 with a header 510 and a body portion 512 with an alternate summary of the transcript 304, and a third screenshot 514 with a header 516 and a body portion 518 with another alternate summary of the transcript 304.

FIG. 5 illustrates that multiple summaries may be generated from the single transcript 304, in order to accommodate available screen sizes, user preferences, and summary contexts. For example, the body portion 506 of the screenshot 502 includes a summary of “Hello! Good morning! We have a guest speaker this morning, Dr. Alan Kay.”

For example, the preceding summary may be selected and formatted to fit available screen space in the screenshot 502. For example, the preceding summary may be limited to a specified number of lines (e.g., lines 1-4), each with a specified number of words (e.g., maximum of 4 words each), and may be required to end with punctuation (e.g., a period, as shown).

In another example, the body portion 512 of the screenshot 508 includes a summary, “Hi! Thank you very much for coming. Today we have a guest speaker, Dr. Alan Kay.” As shown, the available screen space is slightly larger than the example of the screenshot 502, and the preceding summary is provided with 5 lines of text, and contains somewhat more of the original transcript 304.

In another example, the body portion 518 of the screenshot 514 includes a summary, “Hello! Good morning everyone. Thank you for coming today. We have a special guest speaker, Dr. Alan Kay . . . ” The preceding summary illustrates an example in which more of the available screen space is utilized, and the summary is provided in a scrolling fashion, as indicated by the ellipses at the end of the summary.

The screenshots 502, 508, 514 may be constrained or otherwise defined using one or more of the device characteristics 108 and/or the user preferences 110 in FIG. 1. For example, the device characteristics 108 may specify maximum values of, e.g., number of lines and/or number of words per line, which may directly or indirectly impact other parameters, such as font size. The device characteristics 108 may also specify a minimum or maximum scroll rate of a relevant display, along with any other display parameters and associated minimum, maximum, or optimal value(s).

Summaries may be provided in any manner desired to optimize readability or other preferences of the user 101. For example, the summaries may be restricted from being displayed with an ending in the middle of a sentence, clause, or phrase. For example, a generated summary may be truncated at a most-recent punctuation mark, and a remainder of the summary, if any, may be provided on a subsequent screen.

The headers 504, 510, 516 may include virtually any information that may be useful to the user 101 in interpreting, understanding, or otherwise using the summary stream provided in the respective body portions 506, 512, 518. For example, as shown in the example headers 504, 510, 516, headers may indicate that the displayed text is part of a summary. In other examples, a header may indicate that a corresponding body portion is a transcript and/or a translation.

In further examples, one of the headers 504, 508, 514 may indicate that summarization operations are processing and/or have been processed (e.g., that the transcript 304 is currently being processed by the summarizer 136). For example, in addition to indicating that summarization is being performed, there may be a delay associated with inputting the transcript 304 and outputting a corresponding summary, and the headers 504, 508, 516 may be useful in conveying a corresponding summarization status to the user 101, until a summary is ready to be included within a corresponding body portion 506, 512, 518.

FIG. 6 illustrates an example summary selection process for use in the example of FIGS. 3 and 4. In the example of FIG. 6, an input transcript 602 is illustrated as, “Last week I went to the theater, I had a very good seat, the play was very interesting, but I did not enjoy it, a young man and a young woman were sitting behind me they were talking loudly. I got very angry, I could not hear the actor. I turned around, I looked at the man and the young woman angrily. They did not pay any attention, in the end I turned around again. I can't hear a word!!!! I said angrily. It's none of your business, the young man said rudely. This is a private conversation!”

FIG. 6 further illustrates that many summaries 604-618 may be generated from the input transcript 602. For example, a summary 604 includes “I saw.” A summary 606 includes, “I went to the theater and was annoyed by a couple.” A summary 608 includes, “I went to the theater. The play was interesting but I did not enjoy it because there were two people talking loudly behind me.” A summary 610 includes a list item “1) Go to theater”. A summary 612 includes, “I went to the theater and had a good seat, but was unable to hear the play.” A summary 614 includes, “I went to the theater and was annoyed by a couple.” A summary 616 includes, “Last week, I went to the theater. I had a very good seat. The play was very interesting, but I did not enjoy it. A summary 618 includes the list item “1) Go to theater.”

FIG. 6 thus illustrates that multiple summaries may be generated for a single input transcript. For example, the summarizer 136 may generate multiple such summaries, and then select the summary that will be best-fit with respect to the device characteristics 108 and/or the user preferences 110. In such examples, remaining summaries may be discarded without review by the user 101.

In other examples, the user 101 may be provided with two or more summaries, and may select a desired summary. For example, as referenced above, the user 101 may wish to retain one or more summaries in long term memory, e.g., for later use following a conversation or lecture. In these or similar situations, the user 101 may wish to select a most-desired summary for long term storage.

FIG. 7 is a third person view of a user 702 (analogous to the user 101 of FIG. 1) in an ambient environment 7000, with one or more external computing systems shown as additional resources 752 that are accessible to the user 702 via a network 7200. FIG. 7 illustrates numerous different wearable devices that are operable by the user 702 on one or more body parts of the user 702, including a first wearable device 750 in the form of glasses worn on the head of the user, a second wearable device 754 in the form of ear buds worn in one or both ears of the user 702, a third wearable device 756 in the form of a watch worn on the wrist of the user, and a computing device 706 held by the user 702. In FIG. 7, the computing device 706 is illustrated as a handheld computing device, but may also be understood to represent any personal computing device, such as a table or personal computer.

In some examples, the first wearable device 750 is in the form of a pair of smart glasses including, for example, a display, one or more images sensors that can capture images of the ambient environment, audio input/output devices, user input capability, computing/processing capability and the like. Additional examples of the first wearable device 750 are provided below, with respect to FIGS. 8A and 8B.

In some examples, the second wearable device 754 is in the form of an ear worn computing device such as headphones, or earbuds, that can include audio input/output capability, an image sensor that can capture images of the ambient environment 7000, computing/processing capability, user input capability and the like. In some examples, the third wearable device 756 is in the form of a smart watch or smart band that includes, for example, a display, an image sensor that can capture images of the ambient environment, audio input/output capability, computing/processing capability, user input capability and the like. In some examples, the handheld computing device 706 can include a display, one or more image sensors that can capture images of the ambient environment, audio input/output capability, computing/processing capability, user input capability, and the like, such as in a smartphone. In some examples, the example wearable devices 750, 754, 756 and the example handheld computing device 706 can communicate with each other and/or with external computing system(s) 752 to exchange information, to receive and transmit input and/or output, and the like. The principles to be described herein may be applied to other types of wearable devices not specifically shown in FIG. 7 or described herein.

The user 702 may choose to use any one or more of the devices 706, 750, 754, or 756, perhaps in conjunction with the external resources 752, to implement any of the implementations described above with respect to FIGS. 1-6C. For example, the user 702 may use an application executing on the device 706 and/or the smartglasses 750 to receive, transcribe, and display the transcription stream 130 of FIG. 1 and/or the summary stream 134 of FIG. 1.

As referenced above, the device 706 may access the additional resources 752 to facilitate the various summarization techniques described herein, or related techniques. In some examples, the additional resources 752 may be partially or completely available locally on the device 706. In some examples, some of the additional resources 752 may be available locally on the device 706, and some of the additional resources 752 may be available to the device 706 via the network 7200. As shown, the additional resources 752 may include, for example, server computer systems, processors, databases, memory storage, and the like. In some examples, the processor(s) may include training engine(s), transcription engine(s), translation engine(s), rendering engine(s), and other such processors. In some examples, the additional resources may include ML model(s), such as the various ML models of the architectures of FIGS. 1 and/or 3.

The device 706 may operate under the control of a control system 760. The device 706 can communicate with one or more external devices, either directly (via wired and/or wireless communication), or via the network 7200. In some examples, the one or more external devices may include various ones of the illustrated wearable computing devices 750, 754, 756, another mobile computing device similar to the device 706, and the like. In some implementations, the device 706 includes a communication module 762 to facilitate external communication. In some implementations, the device 706 includes a sensing system 764 including various sensing system components. The sensing system components may include, for example, one or more image sensors 765, one or more position/orientation sensor(s) 764 (including for example, an inertial measurement unit, an accelerometer, a gyroscope, a magnetometer and other such sensors), one or more audio sensors 766 that can detect audio input, one or more touch input sensors 768 that can detect touch inputs, and other such sensors. The device 706 can include more, or fewer, sensing devices and/or combinations of sensing devices.

Captured still and/or moving images may be displayed by a display device of an output system 772, and/or transmitted externally via a communication module 762 and the network 7200, and/or stored in a memory 770 of the device 706. The device 706 may include one or more processor(s) 774. The processors 774 may include various modules or engines configured to perform various functions. In some examples, the processor(s) 774 may include, e.g., training engine(s), transcription engine(s), translation engine(s), rendering engine(s), and other such processors. The processor(s) 774 may be formed in a substrate configured to execute one or more machine executable instructions or pieces of software, firmware, or a combination thereof. The processor(s) 774 can be semiconductor-based including semiconductor material that can perform digital logic. The memory 770 may include any type of storage device or non-transitory computer-readable storage medium that stores information in a format that can be read and/or executed by the processor(s) 774. The memory 770 may store applications and modules that, when executed by the processor(s) 774, perform certain operations. In some examples, the applications and modules may be stored in an external storage device and loaded into the memory 770.

Although not shown separately in FIG. 7, it will be appreciated that the various resources of the computing device 706 may be implemented in whole or in part within one or more of various wearable devices, including the illustrated smartglasses 750, earbuds 754, and smartwatch 756, which may be in communication with one another to provide the various features and functions described herein. For example, the memory 770 may be used to implement the transcription buffer 128 and the summary buffer 132.

In FIG. 7, any audio and/or video output may be used to provide the types of summaries described herein, and associated features. For example, described techniques may be implemented in any product in which improving speech-to-text would be helpful and in which high-quality summaries would be beneficial. Beyond head-worn displays, wearables, and mobile devices, described techniques may be used in remote conferencing and web apps (including, e.g., providing captions/summaries within web conferencing software and/or pre-recorded videos).

Described techniques may also be useful in conjunction with translation capabilities, e.g., of the additional resources 752. For example, the user 702 may listen to a conversation from a separate speaker (corresponding to the speaker 100 of FIG. 1), who may be proximate to, or removed from, the user 702), where the speaker may be speaking in a first language. A translation engine of the processors of the additional resources 752 may provide automated translation of the dialogue into a native language of the user 702, and also may summarize the translated dialogue using techniques described herein.

The architecture of FIG. 7 may be used to implement or access one or more large language models (LLMs), which may be used to implement a summarizer for use in the preceding examples. For example, the Pathways Language Model (PaLM) and/or the Language Model for Dialogue Application (LaMDA), both provided by Google, Inc., may be used. For example, these and other LLMs may be implemented using a neural network architecture known as transformer architecture, designed to process data sequentially and determine relationships/connections within training input(s) using a self-attention mechanism that assigns a score (or weight) to each item (or token), which are then used later to determine an output for a currently-received input.

An example head mounted wearable device 800 in the form of a pair of smart glasses is shown in FIGS. 8A and 8B, for purposes of discussion and illustration. The example head mounted wearable device 800 includes a frame 802 having rim portions 803 surrounding glass portion, or lenses 807, and arm portions 830 coupled to a respective rim portion 803. In some examples, the lenses 807 may be corrective/prescription lenses. In some examples, the lenses 807 may be glass portions that do not necessarily incorporate corrective/prescription parameters. A bridge portion 809 may connect the rim portions 803 of the frame 802. In the example shown in FIGS. 8A and 8B, the wearable device 800 is in the form of a pair of smart glasses, or augmented reality glasses, simply for purposes of discussion and illustration.

In some examples, the wearable device 800 includes a display device 804 that can output visual content, for example, at an output coupler providing a visual display area 805, so that the visual content is visible to the user. In the example shown in FIGS. 8A and 8B, the display device 804 is provided in one of the two arm portions 830, simply for purposes of discussion and illustration. Display devices 804 may be provided in each of the two arm portions 830 to provide for binocular output of content. In some examples, the display device 804 may be a see through near eye display. In some examples, the display device 804 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 807, next to content (for example, digital images, user interface elements, virtual content, and the like) output by the display device 804. In some implementations, waveguide optics may be used to depict content on the display device 804.

The example wearable device 800, in the form of smart glasses as shown in FIGS. 8A and 8B, includes one or more of an audio output device 806 (such as, for example, one or more speakers), an illumination device 808, a sensing system 810, a control system 812, at least one processor 814, and an outward facing image sensor 816 (for example, a camera). In some examples, the sensing system 810 may include various sensing devices and the control system 812 may include various control system devices including, for example, the at least one processor 814 operably coupled to the components of the control system 812. In some examples, the control system 812 may include a communication module providing for communication and exchange of information between the wearable device 800 and other external devices. In some examples, the head mounted wearable device 800 includes a gaze tracking device 815 to detect and track eye gaze direction and movement. Data captured by the gaze tracking device 815 may be processed to detect and track gaze direction and movement as a user input. In the example shown in FIGS. 8A and 8B, the gaze tracking device 815 is provided in one of two arm portions 830, simply for purposes of discussion and illustration. In the example arrangement shown in FIGS. 8A and 8B, the gaze tracking device 815 is provided in the same arm portion 830 as the display device 804, so that user eye gaze can be tracked not only with respect to objects in the physical environment, but also with respect to the content output for display by the display device 804. In some examples, gaze tracking devices 815 may be provided in each of the two arm portions 830 to provide for gaze tracking of each of the two eyes of the user. In some examples, display devices 804 may be provided in each of the two arm portions 830 to provide for binocular display of visual content.

The wearable device 800 is illustrated as glasses, such as smartglasses, augmented reality (AR) glasses, or virtual reality (VR) glasses. More generally, the wearable device 800 may represent any head-mounted device (HMD), including, e.g., a hat, helmet, or headband. Even more generally, the wearable device 800 and the computing device 706 may represent any wearable device(s), handheld computing device(s), or combinations thereof.

Use of the wearable device 800, and similar wearable or handheld devices such as those shown in FIG. 7, enables useful and convenient use case scenarios of implementations of the systems of FIGS. 1-4. For example, such wearable and handheld devices may be highly portable and therefore available to the user 702 in many different scenarios. At the same time, available display areas of such devices may be limited. For example, the display area 805 of the wearable device 800 may be a relatively small display area, constrained by an overall size and form factor of the wearable device 800.

Consequently, the user 702 may benefit from use of the various summarization techniques described herein. For example, the user 702 may engage in interactions with separate speakers, such as a lecturer or a participant in a conversation. The user 702 and the separate speaker may have varying degrees of interactivity or back-and-forth, and two or more additional speakers may be present, as well.

Using described techniques, the user 702 may be provided with dynamic, real-time summarizations during all such interactions, as the interactions are happening. For example, the speaker may speak for a short time or a longer time, in conjunction with (e.g., in response to) dialogue provided by the user 702. During all such interactions, the user 702 may be provided with useful and convenient summaries of words spoken by the separate speaker(s).

As described, the dynamic, real-time summarizations may be dynamically adjusted over time and during the course of a conversation or other interaction. As a result, the user 101/702 may be provided with meaningful, situation-specific summaries that reduce a cognitive load of the user 101/702 and facilitate meaningful interactions, even when one or more participants in the interaction(s) is not a native speaker, or is currently speaking a different language, or is an expert in a field speaking to a novice in the field.

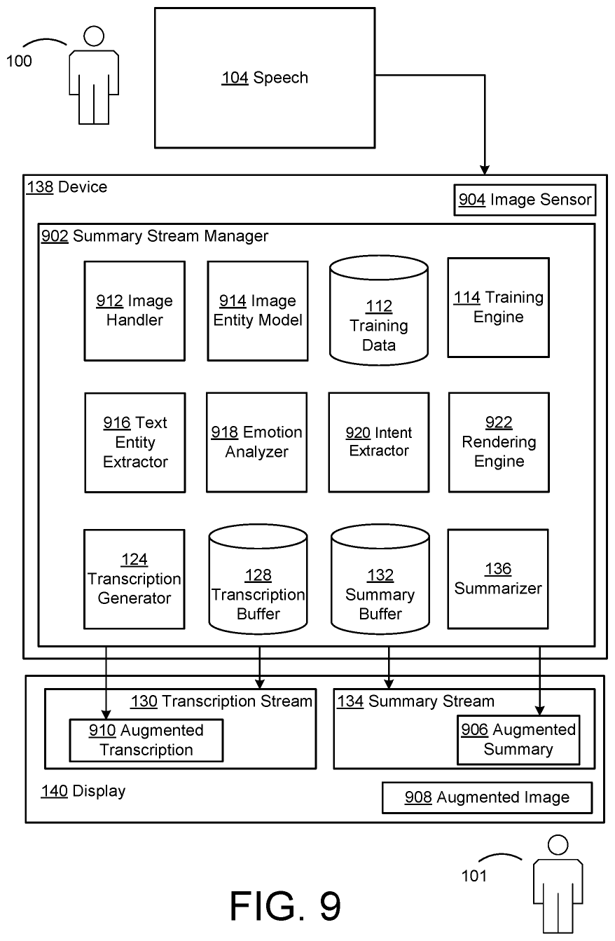

FIG. 9 is a block diagram of an alternate implementation of the system of FIG. 1 for visual augmentation of transcribed text. In the example of FIG. 9, a summary stream manager 902 represents an alternate implementation of the summary stream manager 102 of FIG. 1, and may include any one or more of the various components or subcomponents already described in the context of the example of FIG. 1. Consequently, such components or subcomponents are not described again here, except as may be helpful in understanding operations of the implementation of FIG. 9.

In the example of FIG. 9, the device 138 includes, or has access to, an image sensor 904. For example, the image sensor 904 may represent the image sensor 765 of FIG. 7, or the image sensor 816 of FIGS. 8A and 8B, or any suitable camera that may be available to the user 101.

In addition, the summary stream manager 902 is configured to provide various types of augmentation to text produced by the summary stream manager 902, so that the summary 106 of FIG. 1 is shown in FIG. 9 as augmented summary 906. Similarly, the transcription 126 of FIG. 1 is shown in FIG. 9 as augmented transcription 910. Detailed descriptions of example types of augmentation are provided below, but in general, such augmentations may include, e.g., emotional augmentation, entity augmentation, and/or intention augmentation. In other words, for example, the augmented summary 906 or the augmented transcription 910 may be augmented to highlight or emphasize emotions of the speaker 100 or the user 101, important or meaningful entities mentioned within the generated text, or an intention of the speech 104. As also described below, any such augmentation may be provided either by changing (e.g., visually highlighting) text of the augmented summary 906 or the augmented transcription 910, or by providing additional information in addition to generated text (including, e.g., some or all of an image captured by the image sensor 904).

Further in FIG. 9, an augmented image 908 represents an image captured by the image sensor 904 and augmented by operations of the summary stream manager 902 of FIG. 9. For example, as described in detail, below, some or all of the augmented summary 906 may be added to, combined with, superimposed on, or otherwise provided with an image from the image sensor 904 to produce the augmented image 908. The user 101 may then easily share or use the augmented image 908 in any desired fashion, including, e.g., sending the augmented image 908 to a friend or colleague for purposes of sharing or discussing the speech 104 or associated experiences of the user 101 occurring in conjunction with the speech 104.

In some implementations, the image captured by the image sensor 904 may be added to a summary (e.g., the summary 106 of FIG. 1) generated by the summarizer 136 and therefore form part of the augmented summary 906. Similarly, the image captured by the image sensor 904 may be added to a transcription (e.g., the transcription 126 of FIG. 1) generated by the transcription generator 124 and therefore form part of the augmented transcription 910. In other examples, the augmented image 908 may be formed by adding a transcription (e.g., the transcription 126) to the image captured by the image sensor 904.

In more detail, as shown, the summary stream manager 902 may include an image handler 912. The image handler 912 may be configured to interact or interface with the image sensor 904 and/or with any memory used to store images captured by the image sensor 904. For example, when the summary stream manager 902 has been activated to capture the speech 104 and produce the transcription stream 130 and the summary stream 134, the image handler 912 may be automatically activated and connected with the image sensor 904, so that any image captured by the image sensor while the summary stream manager 902 is active may be received by the image handler 912 by default.

In other examples, an image captured by the image sensor while the summary stream manager 902 is active may be manually designated by the user 101 for use in forming one or more of the augmented summary 906, the augmented image 908, and/or the augmented transcription 910. For example, while the speaker 100 is producing the speech 104, the user 101 may use the image sensor 904 to capture an image, and the image handler 912 may display the captured image, using the display 140, with an option to combine the captured image with a concurrently captured summary or transcript. Additional options may be displayed that enable the user 101 to combine the captured image with a concurrently captured summary or transcript in a desired manner, e.g., by positioning some or all of a summary at a desired location within the image and/or by editing the summary (or transcript).

An image entity model 914 may represent a ML model that is trained by the training engine 114 to extract one or more entities from images captured by the image sensor 904. For example, the image entity model 914 may identify entities within images received by the image handler 912. For example, the image entity model 914 may represent a neural network, such as a convolutional neural network (CNN), an image classifier, a segmentation model, and/or any appropriate object or entity recognition model.

Somewhat similarly, a text entity extractor 916 may be configured to identify one or more entities within either or both of transcription text output by the transcription generator 124 (e.g., the transcription 126 of FIG. 1) or of summary text output by the summarizer 136 (e.g., the summary 106 of FIG. 1). For example, the text entity extractor 916 may represent any trained model or algorithm designed to identify and extract content that may be useful or important with respect to summary/transcription augmentation as described herein. For example, such extracted content may include any type, category, or instance of information that may be structured in a known manner. Any type of facts, phrases, or other key information may be identified for extraction. Some specific but non-limiting examples of such content may include, e.g., named entities, such as persons, things, dates, times, events, locations, or the like.

During operation, the text entity extractor 916 may identify, within the transcription stream 130 and/or the summary stream 134, one or more such entities in an ongoing basis as the transcription stream 130 and/or the summary stream 134 are received. The text entity extractor 916 may be configured to assign a probability as to whether each identified entity will or will not (should or should not) be included in the augmented summary 906, the augmented image, and/or the augmented transcription 910.

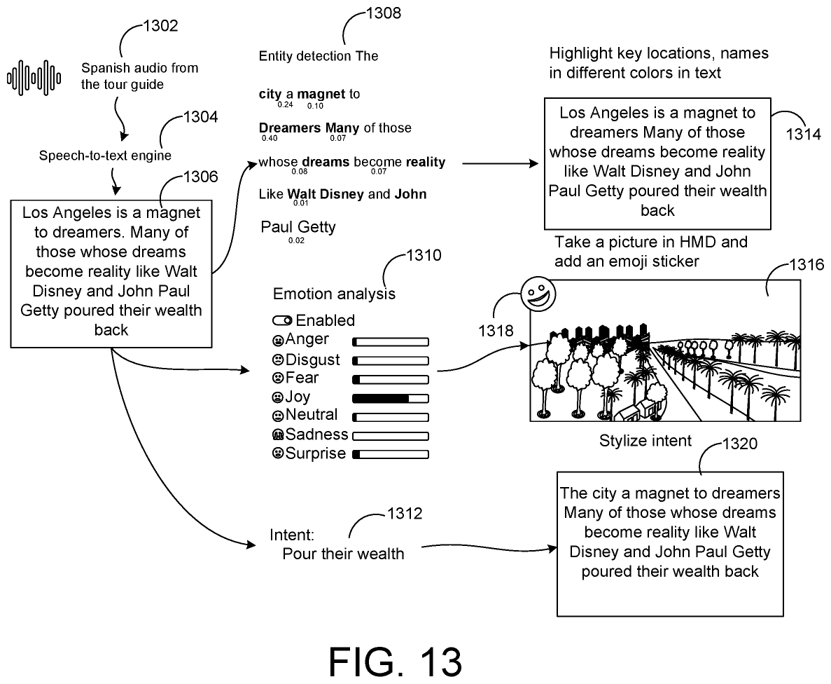

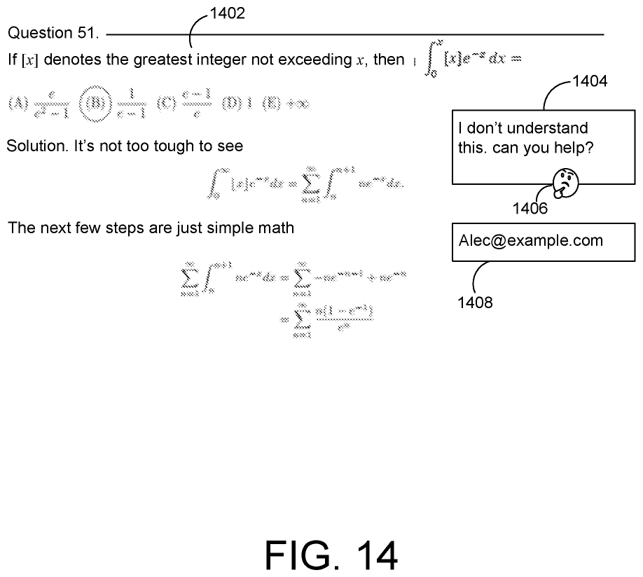

In the case of the image entity model 914 and/or the text entity extractor 916, the training data 112 may thus include many examples of training images and training text, respectively, from which various types and instances of content have been identified and associated as a label that produces a desired object or entity identification. More specific examples are provided below, e.g., with respect to FIGS. 13 and 14.

An emotion analyzer 918 may be configured to analyze text from the transcription generator 124 and associate one or more emotions with corresponding text portions (e.g., corresponding words, phrases, sentences, or paragraphs). For example, as illustrated and described in more detail below with respect to FIG. 13, the emotion analyzer 918 may be associated with a pre-defined set of emotions (e.g., joy, anger, disgust, fear, surprise, and so on), and each of these emotions may be associated with a probability of being present (or not present) at a given point in time as the transcription stream 130 and/or the summary stream 134 is processed.

An intent extractor 920 may be trained and configured to analyze an intention(s) associated with a corresponding portion of the transcription stream 130 at a given point in time. For example, the intent extractor 920 may be trained as a classifier to classify a current intention of the speaker 100 from among a known plurality of intentions, including, e.g., to see, to purchase, to show, to give/receive, to visit, to help, and so on. The intent extractor 920 may be obtained by fine-tuning a pre-trained LLM for intent detection.

A rendering engine 922 may be configured to render various icons, files, or other content on the display 140. For example, the rendering engine 922 may render any of the transcription stream 130, the summary stream 134, the augmented transcription 910, the augmented summary 906, an image captured by the image sensor 904, and/or the augmented image 908. For example, any of the preceding items may be rendered using the visual display area 805 of FIG. 8B. Additional rendering examples are provided below, e.g., with respect to FIGS. 13-16.

Thus, in a simplified example implementation of FIG. 9, the user 101, while having a conversation with the speaker 100 about adopting a dog, may capture an image of the speaker 100 with the dog, using the image sensor 904, to send to a friend. The transcription generator 124 may generate a transcription stream that includes the sentence, “I just adopted him from the shelter on the way home from work yesterday!” The summarizer 136 may output the summary stream 134 that includes a summary of “I got a new dog!”

The text entity extractor 916 may analyze the transcription stream 130 to identify entities such as “I”, “adopted”, “him”, and “shelter”, and/or may analyze the summary stream 134 to identify entities “I” and “new dog”. More specifically, the text entity extractor 916 may identify all entities within the sentence and may assign a value indicating a likelihood of importance of each entity, e.g., on a scale between 0 and 1, for including or considering when generating the augmented transcription 910, the augmented summary 906, and/or the augmented image 908. For example, the text entity extractor 916 may consider the example sentence as “I (0.9) just adopted (0.85) him (0.85) from the shelter (0.7) on the way home (0.35) from work (0.35) yesterday (0.5)!”

The emotion analyzer 918 may analyze the transcription stream 130 and/or the summary stream 134 to identify emotions of excitement and joy. The intent extractor 920 may analyze the transcription stream 130 and/or the summary stream 134 to identify an intention of “to share.”

If the user 101 uses the image sensor 904 to capture an image of the speaker 100 with the speaker's new dog, the image handler 912 may trigger the above analyses and the rendering engine 922 may then generate the augmented summary 906. For example, the augmented summary 906 may include the captured image with a caption of “I got a new dog!” and a corresponding emoji(s) showing joy/excitement. The image entity model 914 may identify entities of person and dog within the captured image, so that the rendering engine 922 may position the emoji(s) and/or caption proximate to the image of the dog within the augmented summary 906. The user 101 may then easily share the augmented summary 906 through any appropriate sharing techniques, including, e.g., text messaging or social media.

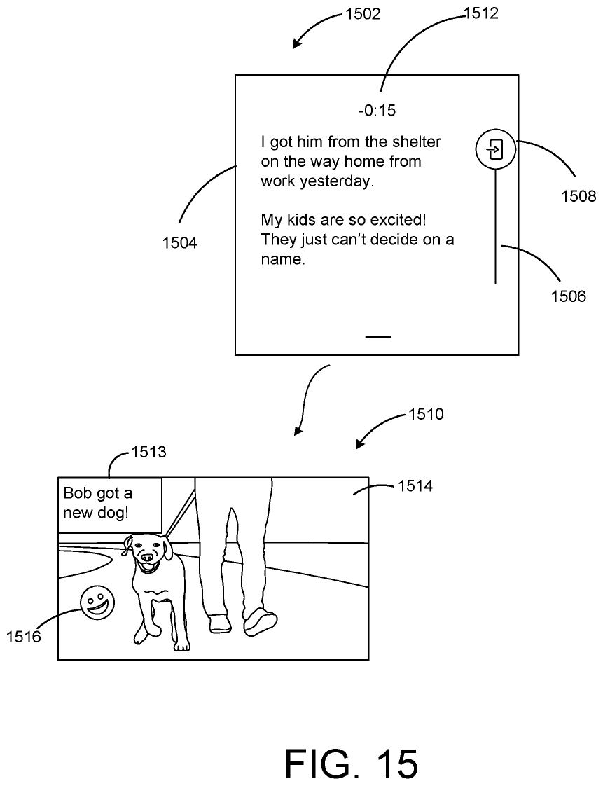

In some examples, as described below with respect to FIG. 15, the user 101 may decide to send such a message at a later point in time during the conversation, after the relevant sentence/summary has occurred. In such cases, the user 101 may use the transcription buffer 128 and/or the summary buffer 132 to send the desired message. For example, at a current time, the user 101 may scroll back through the summary stream 134 to an earlier point in time at which the relevant summary was generated. Capturing the desired image at the current time, using the image sensor 904, and while the summary “I got a new dog” is displayed on the display 134, may thus cause the rendering engine 922 to render the above-described augmented summary 906.

In example implementations, the text entity extractor 916, the emotion analyzer 918, the intent extractor 920, and the summarizer 136 may be trained independently, or may be trained together in groups of two or more. As referenced above, and described in more detail, below, training for each model may be performed with respect to, e.g., input text representing examples of the transcription stream 130 and a ground truth output of the model being trained. In examples in which two or more models are trained together, or trained as a combined model, input text and a ground truth output of each model/type of output may be used, along with a ground truth augmented summary output by the summarizer 136.

For example, to train the text entity extractor 916, the training data 112 may include training records that include training input text and corresponding ground truth text entity type(s). The text entity extractor 916 may thus be used to generate entities from the training input text, which may be compared against ground truth entities. For example, the ground truth entities may be obtained from earlier labeling of the training input text when the training data 112 is created.

When errors occur between the generated entities and the ground truth entities, a type and/or degree of the error may be used by the training engine 114 in a subsequent training iteration to adjust weights or other parameters of the text entity extractor 916. Over multiple iterations, the weights or other parameters may thus be adjusted by the training engine 114 to cause the text entity extractor 916, once deployed, to process the transcription stream 130 and identify included entities, with an acceptable level of accuracy.

Similar comments apply to training of the image entity model 914, the emotion analyzer 918, the intent extractor 920, and the summarizer 136. Consequently, as illustrated and described below, e.g., with respect to FIG. 3, the image entity model 914, the text entity extractor 916, the emotion analyzer 918, the intent extractor 920, and the summarizer 136 may be trained and deployed in a number of different architectures. For example, the various models may be trained in a modular approach, in which each model is trained individually as just described, and outputs of each model may be provided as text outputs that may be input by one or more subsequent models to obtain, e.g., the augmented summary 906.

For example, model outputs of any of the image entity model 914, the text entity extractor 916, the emotion analyzer 918, and the intent extractor 920 may operate on outputs of the transcription generator 124 and provide outputs to the summarizer 136. In such examples, any or all such model outputs may constrain and improve outputs of the summarizer 136. That is, the summarizer 136 in such examples may be trained to emphasize, within the summary stream 134, the entities, emotions, and/or intents identified by available ones of the model outputs. In such examples, when training the summarizer 136 with the training engine 114, the training data 112 may include ground truth entities, emotions, and/or intents along with ground truth summaries that reflect such entities, emotions, and/or intents. Once deployed, the summarizer 136 may thus provide the summary stream 134 in a manner that reflects, e.g., emphasizes or visually distinguishes, e.g., using Markdown language, such entities (including image entities and/or text entities), emotions, and/or intents.

In other examples, when transformer-based LLMs are used, inputs may be set as vector embeddings, and a single combined model may be trained to input just the transcription stream 130 and the image captured by the image sensor 904, and output, e.g., the augmented summary 906 (or the augmented transcript 910 or the augmented image 908).

Many other implementations are possible. For example, model outputs may be defined in terms of knowledge graph representations, rather than textually or as vector embeddings. Additionally, as referenced, two or more of the included models may be trained jointly, e.g., using such knowledge graph representations, or other output schemes. Still further, additional or alternative models may be used, e.g., additional or alternative classifiers may be used, and one or more of the illustrated models may be modified or omitted.

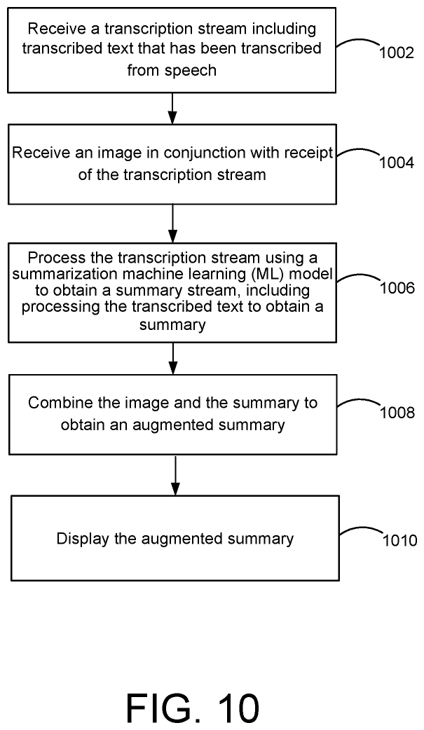

FIG. 10 is a flowchart illustrating example operations of the system of FIG. 1. In the example of FIG. 10, operations 1002-1010 are illustrated as separate, sequential operations. However, in various example implementations, the operations 202-210 may be implemented in a different order than illustrated, in an overlapping or parallel manner, and/or in a nested, iterative, looped, or branched fashion. Further, various operations or sub-operations may be included, omitted, or substituted.

In FIG. 10, a transcription stream 130 including transcribed text that has been transcribed from speech 104 may be received (1002). For example, as described, the transcription generator 124 may generate the transcription stream 130.

An image may be received in association with, e.g., in conjunction with, receipt of the transcription stream (1004). For example, the image handler 912 may be configured to receive an image from the image sensor 904.

The transcription stream 130 may be processed using a summarization machine learning (ML) model to obtain a summary stream 134, including processing the transcribed text to obtain a summary (1006). For example, the summarizer 136 may process the transcription stream 130 to obtain the summary stream 134.

The image and the summary may be combined to obtain an augmented summary 906 (1008), and the augmented summary may be displayed (1010). For example, the rendering engine 922 may combine an output of the summarizer 136 and the image handler 912, perhaps in conjunction with outputs of one or more of the image entity model 914, the text entity extractor 916, the emotion analyzer 918, and the intent extractor 920, to provide the augmented summary 906 (and/or the augmented transcription 910 or the augmented image 908).

In some implementations, the capture of the image may provide a trigger for generation of the augmented summary 906. For example, when an image is captured at a current time, a time interval before and/or after the image capture trigger may be defined, and the augmented summary 906 or the augmented transcription 910 may be defined with respect to text generated that correspond to (falls within) the defined time interval. When the image is captured after the user 101 has scrolled back through the transcription stream 130 or the summary stream 134, the image capture trigger may define a similar time interval before and after a timestamp at which scrolling ended for purposes of generating the augmented summary 906 or the augmented transcription 910.

In addition, as referenced above, output from any of the image entity model 914, the text entity extractor 916, the emotion analyzer 918, and/or the intent extractor 920 may be included in the augmented summary 906, the augmented transcription 910, or the augmented image 908. For example, identified entities (either image entities or text entities) may be highlighted, pointed to by an arrow or other visual indicator, provided in a different font color or in a different font, or provided as a link to external information (e.g., to corresponding internet search results). Emotions may be indicated through the use of corresponding emojis, or by textual additions, such as “So exciting!” Determined intentions may be added, such as “Just wanted to share this with you.”

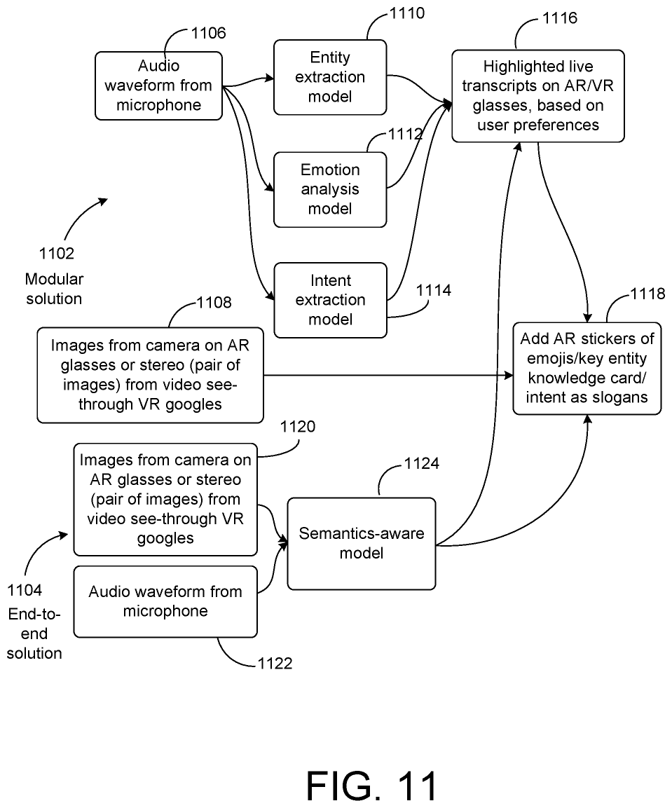

FIG. 11 is a block diagram illustrating more detailed example implementations of the system of FIG. 9. FIG. 11 illustrates a modular solution 1102 and an end-to-end solution 1104. In the modular solution 1102, audio 1106 is received at a microphone while an image 1108 is received, e.g., from a camera on AR glasses such as illustrated in FIGS. 7, 8A, and 8B, or as a stereo image or image pair from video see-through VR goggles.

As shown in the example, the audio 1106 may be received and processed, including undergoing STT, ASR, or similar processing, and/or summarization by the summarizer 136, all not shown separately in FIG. 11. Subsequently in the example, an entity extraction model 1110 may identify entities within the received audio 1106, including assigning a probability as to whether each identified entity should be included when generating subsequent augmented output. For example, the entity extraction model 1110 may be run locally to the head mounted wearable device 800, including use of a local device in wireless communications with the head mounted wearable device 800.

An emotion analysis model 1112 may, in parallel, process the audio 1106 to determine and characterize one or more emotions associated with the audio 1106 over time. That is, for example, as the transcription stream 130 and the summary stream 134 are received over time in conjunction with receipt of the speech 104, the emotion analysis model 1112 may continuously or periodically update a current associated emotion(s), or most-likely emotion(s). The emotion analysis model 1112 may executed, for example, as a cloud-based model.

Similarly, an intent extraction model 1114 may be executed in parallel with the entity extraction model 1110 and the emotion analysis model 1112. In processing the audio 1106, the intent extraction model 1114 may determine, when feasible, a current intention of the speaker 100. For example, in some cases, intention may be determined after only a few words spoken by the speaker 100, while in other cases, no intention may be apparent, or a longer segment of speech 104 may be required before an intention may be determined. Consequently, the intent extraction model 1114 may operate in parallel with the entity extraction model 1110 and the emotion analysis model 1112, but may output a determined intention only when available.

Accordingly, highlighted live transcripts 1116 may be provided as augmented transcripts/summaries, e.g., on AR/VR glasses such as the head mounted wearable device 800, based on user preferences, such as the user preferences 110 of FIG. 1. For example, the user 101 may wish to continuously view the transcription stream 130 and/or the summary stream 134 with identified entities determined by the entity extraction model 1110, indications of emotions determined by the emotion analysis model 1112, and/or detected intents from the intent extraction model 1114. If the user 101 finds one or more of these outputs to be distracting or undesired, the user 101 may individually disable such outputs from being displayed in conjunction with the transcription stream 130 or the summary stream 134.

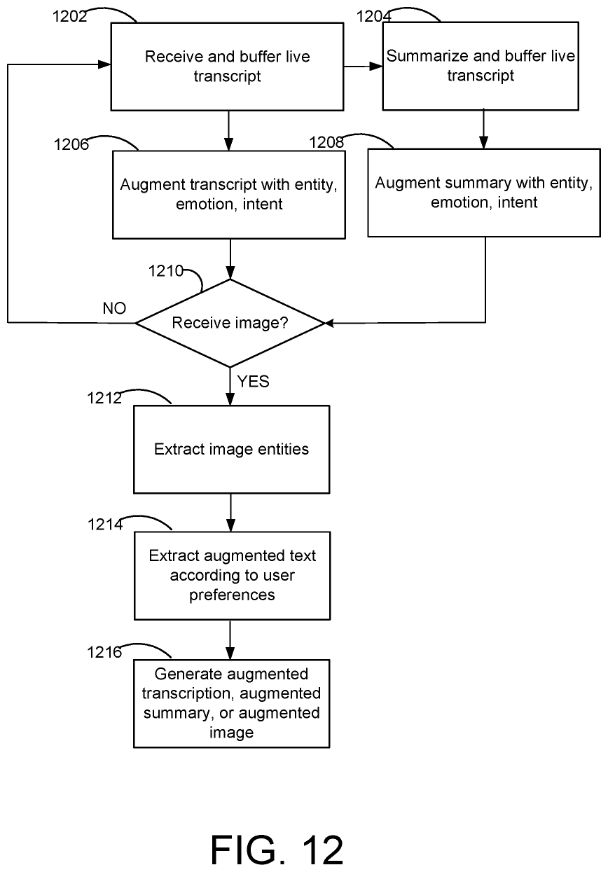

In some such cases, the summary stream manager 902 may continue to execute the entity extraction model 1110, the emotion analysis model 1112, and the intent extraction model 1114 and obtain corresponding outputs. Such outputs may be stored within the transcription buffer 128 or the summary buffer 132, e.g., for use in potential subsequent summary augmentation operations. In other examples, e.g., to conserve resources or otherwise in accordance with user preferences, one or more of the entity extraction model 1110, the emotion analysis model 1112, and the intent extraction model 1114 may be deactivated or unused until a suitable trigger is detected, such as receipt of the image 1108 at the image handler 912, as referenced above and described in more detail, below, with respect to FIG. 12.

In the example of the modular solution 1102 of FIG. 11, an augmented image 1118 may be provided by combining the highlighted live transcripts 1116 with the image 1108. For example, as illustrated in FIG. 11, the augmented image 1118 may include the image 1108 with augmentations including one or more of AR stickers of emojis, key entity knowledge cards, and/or an intent provided as a slogan for the image 1108.

Also in the example of the modular solution 1102, it will be appreciated from the above description of FIG. 9 that the summarizer 136 may be configured to output to one or more of the models 1110, 1112, 1114, so that the models 1110, 1112, 1114 operate on summarized content. In other examples, conversely, one or more of the models 1110, 1112, 1114 may output to the summarizer 136, so that the summarizer 136 may generate summarized content with the benefit of, or based on, corresponding outputs of the one or more models 1110, 1112, 1114.

Further in FIG. 11, in the end-to-end solution 1104, a semantics-aware model 1124 may be implemented using the above-referenced transformer architecture, with all inputs set to vector embeddings. Then, an image 1120 and audio 1122 (perhaps after STT/ASR processing and/or summarization processing) may be input directly to the semantics-aware model 1124. In this way, the highlighted live transcripts 1116 may be provided as augmented transcripts/summaries directly by the semantics-aware model 1124. The augmented image 1118 may be provided directly by the semantics-aware model 1124 and/or indirectly based on the highlighted live transcripts 1116.

For example, the semantics-aware model 1124 may be trained using all of the training data used to individually train the entity extraction model 1110 the emotion analysis model 1112, and the intent extraction model 1114, as well as the summarizer 136 and the image entity model 914 (not shown separately in FIG. 11). To perform these multiple types of training, the training inputs may be provided with labels and ground truth outputs for the various types of desired outputs. Then, by expressing the training data using vector embeddings, the semantics-aware model 1124 may be trained with respect to common expressions, i.e., in a common language, across the different types of outputs desired. Once deployed, the semantics-aware model 1124 may express live inputs (e.g., the image 1120 and the audio 1122) using vector embeddings, so as to produce the various types of outputs desired.

FIG. 12 is a flowchart illustrating example operations corresponding to the example of FIG. 11. In the example of FIG. 12, a live transcript is received and buffered (1202), such as the transcription stream 130. The live transcript is summarized and buffered (1204).

The transcript may be augmented with entity, emotion, and/or intent information (1206). Additionally, or alternatively, the summary may similarly be augmented with entity, emotion, and/or intent information (1208). As described above, the transcription and summarizing may occur concurrently with the augmentation(s), in which case the augmentation may or may not be displayed. In other examples, the augmentations may be added at a later time, e.g., to selected, buffered transcriptions/summaries, in which case the transcription/summary may initially be provided without augmentation. That is, the transcription and/or the summary may be displayed without or without inclusion of the entity, emotion, and/or intent information, depending, e.g., on user preferences, and the entity, emotion, and/or intent information may be added at a later time, e.g., to content within the transcription buffer 128 or the summary buffer 132.

If no image is received, e.g., by the image handler 912, then the live transcript and subsequent/parallel operations may continue (1210). Upon receipt of an image at the image handler 912, perhaps in conjunction with another augmentation trigger, such as a vocal command by the user 101, the image entity model 914 of FIG. 9 may extract image objects or other entities (1212) from the received image.

Augmented text may then be extracted from either or both of the augmented transcript and/or the augmented summary, according to user preferences (1214). Accordingly, an augmented transcription, augmented summary, or augmented image may be generated (1216).

In the example of FIG. 12, receipt of the image serves as an augmentation trigger to, e.g., construct a message to be sent, or other composite file to be saved or otherwise used by the user 101. In other examples, however, as just referenced, additional or alternative triggers may be used. In addition to the vocal command just referenced, any of the input techniques described herein, e.g., with respect to the input device 142 of FIG. 1, may be used, including pre-defined gestures, taps, or other suitable selection techniques.

The user preferences may define various characteristics relating to, e.g., how much or which content is included in a designated augmentation operation(s). For example, the user 101 may designate which of the entity, emotion, or intent information should be included. In other examples, user preferences may dictate a quantity or type of preceding and subsequent text (relative to when the image request was received) should be used. User preferences may also determine available and/or automated uses for the generated augmented content, including options for messaging, emailing, or posting to social media.

Any or all such user preferences may be further constrained or defined by a content or context of the relevant text/image. For example, different options may be defined that depend on a time, location, or other setting of the user 101 at a time that the image is captured. As referenced above, user preferences may also define an augmentation time interval with respect to one or more augmentation triggers, including receipt of the image. For example, an augmentation trigger may define a time interval between ten seconds before the augmentation trigger to ten seconds after the augmentation trigger, or other suitable interval.

FIGS. 13-15 illustrate example implementations related to the techniques of FIGS. 9-12. As described above, AR glasses such as the example of FIGS. 7 and 8A/8B enable speech-to-text, translation, and image-to-text systems that play an everyday role in users' daily lives. Described techniques enable the conveyance of sentiment, e.g., by including emojis in addition to, or as an alternative to, textual summarization. As described above, while capturing a photo, the user 101 may concurrently make a related statement about the image being captured and see corresponding emoji stickers placed onto the resulting image. Emojis may also be used to convey responses to questions, such as thumbs up/thumbs down or “I don't know” emojis.

Described techniques for extracting entities from transcribed, translated, or summarized text enable highlighting of the entities with such text(s), while intent analysis enables underscoring of the intent of the speech 104. By automatically identifying and semantically annotating objects and scenes in images of transcribed text, described provide additional information that helps users understand the text.

In the example of FIG. 13, the user 101 may be understood to represent a tourist wearing the head mounted wearable device 800, while the speaker 100 represents a tour guide speaking in Spanish. Audio 1302 represents the Spanish audio of the tour guide, and a STT engine 1304 is illustrated as transcribing and translating the audio 1302 into transcribed text 1306. As may be understood from the above, the text 1306 may also be summarized by the summarizer 136.

Upon entity detection 1308 illustrates identification of important entities within the text 1306, along with a probability of importance of each identified entity. Emotion analysis 1310 illustrates an emotion array of anger, disgust, fear, joy, neutral, sadness, and surprise, along with corresponding bars illustrating a current, relative likelihood of each emotion with respect to the audio 1302.

Similarly, intent detection 1312 provides a determined intent associated with the audio 1302. In the example of FIG. 13, the detected intent 1312 “pour their wealth” is determined with respect to the subjects of the audio (i.e., Walt Disney and John Paul Getty), rather than with an intent of the speaker 100 (e.g., tour guide).

Accordingly, augmented text 1314 may be provided. In the augmented text 1314, the most important entities from the entity detection 1308 (such as locations and names) are visually highlighted, e.g., rendered in different colors. An image 1316 may be augmented with an emoji 1318. In an additional or alternative example, augmented text 1320 may have a detected intent visually highlighted, e.g., through bolding/italicizing or other appropriate technique.

In FIG. 14, it is assumed that the user 101 is also the speaker 100, and is working on an example math problem. While looking at the math problem using the head mounted wearable device 800, the user 101 may verbally express an inability to solve the math problem and capture an image 1402 of the math problem.

Then, as shown, transcribed or summarized text 1404 of “I don't understand this equation. Can you help?” may be generated, along with an emoji 1406 visually indicating the lack of understanding. Further, based on user preferences/user choice, a sharing option 1408 may include a selectable email address which the user 101 wishes to use to reach someone for assistance with the math problem 1402.

Thus, FIG. 14 may be understood to represent an augmented image in which the image 1402 is augmented with the text 1404, the emoji 1406, and the sharing option 1408. Conversely, FIG. 14 may also be accurately described as augmented text (e.g., an augmented transcription or augmented summary), in which the image 1402, the emoji 1406, and the sharing option 1408 are added to the text 1404.

Although FIG. 14 is illustrated with respect to a math problem, it will be appreciated that any text may be used in conjunction with, or as the subject of, a captured image. For example, text from a book or article may be captured, and text recognition may be used in conjunction with described image processing techniques to reflect or include recognized text within the augment summary 906 or the augmented image 908.

In FIG. 15, a screenshot 1502 includes a text body 1504 that may represent transcribed or summarized text. A scroll bar 1506 includes a scroll button 1508. As referenced above, the scroll bar 1506 may be used to scroll through text within either the transcription buffer 128 or the summary buffer 132, depending on whether the user 101 has selected a transcription or summary mode. Accordingly, a timestamp 1512 may be provided in conjunction with the scroll bar 1506 to indicate an extent to which the user 101 has scrolled backwards with respect to the provided text. In the screenshot 1502, the timestamp 1512 indicates that the user 101 has scrolled back 15 seconds from most-recent available text.

In the example, the user 101 is having a conversation with a friend named Bob as the speaker 100. At a point in the conversation, the user 101 decides to send a message regarding comments made by the speaker 100 at an earlier point in the conversation. Therefore, the user 101 scrolls back to a relevant point in the conversation using the scroll bar 1506. In the example of FIG. 15, the text 1504 is not highlighted with entity, emotion, or intent information, although such information may have already been determined in conjunction with production of the text 1504. In other examples, the entity, emotion, or intent information may be used to visually augment the text 1504 as the text 1504 is produced, as described in above examples.

To select text to use as the basis for a desired message, the user 101 may move/scroll the scroll button 11508 to be aligned with the desired portion of the text 1504. In other words, in the example, horizontal alignment of the scroll button 1508 with the desired text indicates the desire of the user 101 to generate a message with respect to the aligned text. Aligned text may be defined to be text that is within a time interval before and after the timestamp 1512.

The scroll button 1508 may be a selectable or actionable icon provided by the rendering engine 922. For example, the scroll button 1508 may be used to initiate image capture using the image sensor 904, with the resulting image automatically being provided to the image handler 912. As described above, e.g., with respect to FIG. 12, such image capture may serve as an augmentation trigger to generate a message to be sent.

Accordingly, in FIG. 15, a message 1510 that includes an augmented summary or augmented image includes a summary 1513, shown as “Bob got a new dog!”, an image 1514 of the dog, and an emoji 1516 indicating happiness or joy. The message 1510 may be automatically generated and sent to a predesignated recipient, or the user 101 may have the option to select desired recipients and communication channels. The user 101 may also be provided with an ability to modify the message 1510 before sending, or to save the message 1510 for later use (e.g., for later sending).

In FIG. 15, and in various examples above, operations of the image entity model 914 may identify relevant objects or entities within an image, such as the dog in the image 1514. Such image entities may be visually distinguished within an augmented summary or augmented image, such as in the augmented summary 1510 of FIG. 15.

Although a number of embodiments have been described, many more example implementations are possible. For example, the user 101 may be provided with a choice of augmented content to include. For example, when adding an emoji to show emotion, the user 101 may be provided with the top three predicted emojis, with an option to choose a preferred emoji. In these and other contexts, selections of the user may be used to fine-tune training of the relevant model(s). Similarly, the user 101 may set thresholds to dictate a number or likelihood of entities being identified within a transcription or summary (e.g., a higher or lower confidence threshold for entity detection).

In a first example implementation, referred to herein as example 1, a computer program product is tangibly embodied on a non-transitory computer-readable storage medium and comprises instructions that, when executed by at least one computing device, are configured to cause the at least one computing device to:
receive a transcription stream including transcribed text that has been transcribed from speech;
receive a summary request for a summary to be provided on a display of a device;
identify, from the transcribed text and in response to the summary request, extracted text;
process the extracted text using a summarization machine learning (ML) model to obtain a summary of the extracted text; and
display the summary on the display of the device.

Example 2 includes the computer program product of example 1, wherein the instructions, when executed by the at least one computing device, are further configured to cause the at least one computing device to:
receive the summary request from a user of the device, via an input device of the device.

Example 3 includes the computer program product of example 1 or 2, wherein the input device includes at least one of a touchscreen, a gesture recognition device, a scroll bar, a button, or a microphone.

Example 4 includes the computer program product of any one of the preceding examples, wherein the instructions, when executed by the at least one computing device, are further configured to cause the at least one computing device to:
receive the summary request as a vocal command from a user of the device, via a microphone of the device.

Example 5 includes the computer program product of any one of the preceding examples, wherein the instructions, when executed by the at least one computing device, are further configured to cause the at least one computing device to:
receive the transcription stream from a speech recognition engine.

Example 6 includes the computer program product of example any one of the preceding examples, wherein the device includes a head-mounted display (HMD) and the display includes an HMD display, and wherein the instructions, when executed by the at least one computing device, are further configured to cause the at least one computing device to:
display the transcription stream using the HMD display.

Example 7 includes the computer program product of example any one of the preceding examples, wherein the instructions, when executed by the at least one computing device, are further configured to cause the at least one computing device to:
identify the extracted text as including text received at the device prior to the summary request; and
extract the extracted text from a transcription buffer.

Example 8 includes the computer program product of example any one of the preceding examples, wherein the instructions, when executed by the at least one computing device, are further configured to cause the at least one computing device to:
identify the extracted text as including text received after the summary request; and
extract the extracted text from the transcription stream after the summary request.

Example 9 includes the computer program product of example any one of the preceding examples, wherein the instructions, when executed by the at least one computing device, are further configured to cause the at least one computing device to:
generate at least two summaries using the summarization ML model, including the summary; and
select the summary from the at least two summaries based on device characteristics of the device and on user preferences of a user of the device.

Example 10 includes the computer program product of example any one of the preceding examples, wherein the device includes a head-mounted display (HMD) and the display includes an HMD display, and wherein the instructions, when executed by the at least one computing device, are further configured to cause the at least one computing device to:
display the summary using the HMD display.

In an eleventh example, referred to herein as example 11, a device includes:
at least one processor;
at least one memory;
at least one input device; and
at least one display, wherein instructions stored using the at least one memory, when executed by the at least one processor, cause the device to:
   receive a transcription stream including transcribed text that has been transcribed from speech;
   receive, via the input device, a summary request for a summary to be provided on the at least one display;
   identify, from the transcribed text and in response to the summary request, extracted text;
   process the extracted text using a summarization machine learning (ML) model to obtain a summary of the extracted text; and
   display the summary on the at least one display.

Example 12 includes the device of example 11, wherein the device includes a head-mounted display (HMD).

Example 13 includes the device of example 11 or 12, wherein the device is configured to receive the transcription stream and the summary from a second device in communication with the device.

Example 14 includes the device of any one of the preceding examples 11-13, wherein the input device includes at least one of a touchscreen, a gesture recognition device, a scroll bar, a button, or a microphone.

Example 15 includes the device of example 14, wherein the input device includes a microphone, and the summary request is received as a vocal command from a user of the device, via the microphone.

In a sixteenth example, referred to herein as example 16, a method includes: receiving a transcription stream including transcribed text that has been transcribed from speech;
receiving a summary request for a summary to be provided on a display of a device;
identifying, from the transcribed text and in response to the summary request, extracted text;
processing the extracted text using a summarization machine learning (ML) model to obtain a summary of the extracted text; and
displaying the summary on the display of the device.

Example 17 includes the method of example 16, further comprising: storing the summary with the summary request as labeled training data; and training the summarization ML model using the labeled training data.

Example 18 includes the method of example 17, further comprising:
detecting a second summary request using the summarization ML model after the training; and
summarizing second extracted text using the summarization ML model.

Example 19 includes the method of example 16, wherein the device includes a head-mounted display (HMD) and the display includes an HMD display, and further comprising: displaying the summary using the HMD display.

Example 20 includes the method of example 16, further comprising:
generating at least two summaries using the summarization ML model, including the summary; and
selecting the summary from the at least two summaries based on device characteristics of the device and on user preferences of a user of the device.

A twenty-first example, referred to herein as example 21, includes a computer program product, the computer program product being tangibly embodied on a non-transitory computer-readable storage medium and comprising instructions that, when executed by at least one computing device, are configured to cause the at least one computing device to:
receive a transcription stream including transcribed text that has been transcribed from speech;
receive an image associated with receipt of the transcription stream;
process the transcription stream using a summarization machine learning (ML) model to obtain a summary stream, including processing the transcribed text to obtain a summary;
combine the image and the summary to obtain an augmented summary; and
display the augmented summary.

Example 22 includes the computer program product of example 21, wherein the instructions, when executed by the at least one computing device, are further configured to cause the at least one computing device to:
select a time interval based on receiving the image; and
extract the summary from a portion of the summary stream corresponding to the time interval.

Example 23 includes the computer program product of example 21 or 22, wherein the instructions, when executed by the at least one computing device, are further configured to cause the at least one computing device to:
process the transcribed text using a text entity extractor ML model to identify an entity within the transcribed text; and
display the augmented summary with the entity visually distinguished therein.

Example 24 includes the computer program product of any of examples 21-23, wherein the instructions, when executed by the at least one computing device, are further configured to cause the at least one computing device to:
process the transcribed text using an emotion analyzer ML model to identify an emotion associated with the transcribed text; and
display the augmented summary with the emotion visually distinguished therein.

Example 25 includes the computer program product of example 24, wherein the emotion is indicated by inclusion of a corresponding emoji.

Example 26 includes the computer program product of any of the preceding examples 21-25, wherein the instructions, when executed by the at least one computing device, are further configured to cause the at least one computing device to:
process the image using an image entity extractor ML model to identify an entity within the image; and
display the augmented summary with the entity visually distinguished therein.

Example 27 includes the computer program product of any of the preceding examples 21-26, wherein the instructions, when executed by the at least one computing device, are further configured to cause the at least one computing device to:
process the transcribed text using an intent extractor ML model to identify an intention associated with the transcribed text; and
display the augmented summary with the intention visually distinguished therein.

Example 28 includes the computer program product of any of the preceding examples 21-27, wherein the instructions, when executed by the at least one computing device, are further configured to cause the at least one computing device to:
combine the image and the transcribed text to obtain an augmented transcription; and
display the augmented transcription.

Example 29 includes the computer program product of any of the preceding examples 21-28, wherein the at least one computing device includes a head-mounted display (HMD), and wherein the instructions, when executed by the at least one computing device, are further configured to cause the at least one computing device to:
display the augmented summary using the HMD.

Example 30 includes the computer program product of any of the preceding examples 21-29, wherein the instructions, when executed by the at least one computing device, are further configured to cause the at least one computing device to:
display at least one stream of the transcription stream and the summary stream with a scroll bar having a scroll button;
receive a movement of the scroll button that aligns the scroll button with text of the transcription stream or the summary stream; and
generate the augmented summary based on a selection of the scroll button while aligned with the text.

A thirty-first example, referred to herein as example 31, includes a device comprising:
at least one processor;
at least one memory;
at least one input device; and
at least one display, wherein instructions stored using the at least one memory, when executed by the at least one processor, cause the device to:
receive a transcription stream including transcribed text that has been transcribed from speech;
receive an image associated with receipt of the transcription stream;
process the transcription stream using a summarization machine learning (ML) model to obtain a summary stream, including processing the transcribed text to obtain a summary;
combine the image and the summary to obtain an augmented summary; and
display the augmented summary using the at least one display.

Example 32 includes the device of example 31, wherein the device includes a head-mounted display (HMD).

Example 33 includes the device of example 31 or 32, wherein the instructions, when executed by the at least one processor, cause the device to:
select a time interval based on receiving the image; and
extract the summary from a portion of the summary stream corresponding to the time interval.

Example 34 includes the device of any of the preceding examples 31-33, wherein the instructions, when executed by the at least one processor, cause the device to:
process the transcribed text using a text entity extractor ML model to identify an entity within the transcribed text; and
display the augmented summary with the entity visually distinguished therein.

Example 35 includes the device of any of the preceding examples 31-34, wherein the instructions, when executed by the at least one processor, cause the device to:
process the transcribed text using an emotion analyzer ML model to identify an emotion associated with the transcribed text; and
display the augmented summary with the emotion indicated therein.

Example 36 includes the device of any of the preceding examples 31-35, wherein the instructions, when executed by the at least one processor, cause the device to:
process the image using an image entity extractor ML model to identify an entity within the image; and
display the augmented summary with the entity visually distinguished therein.

Example 37 includes the device of any of the preceding examples 31-36, wherein the instructions, when executed by the at least one processor, cause the device to:
process the transcribed text using an intent extractor ML model to identify an intention associated with the transcribed text; and
display the augmented summary with the intention visually distinguished therein.

A thirty-eighth example, referred to herein as example 38, includes a method comprising:
receiving a transcription stream including transcribed text that has been transcribed from speech;
receiving an image associated with receipt of the transcription stream;
processing the transcription stream using a summarization machine learning (ML) model to obtain a summary stream, including processing the transcribed text to obtain a summary;
combining the image and the summary to obtain an augmented summary; and
displaying the augmented summary.

Example 39 includes the method of example 38, further comprising:
displaying the augmented summary on a display of a head-mounted device (HMD).

Example 40 includes the method of example 38 or 39, further comprising:
selecting a time interval based on receiving the image; and
extracting the summary from a portion of the summary stream corresponding to the time interval.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as modules, programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor, or LED (light emitting diode)) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

In some implementations, one or more input devices in addition to the computing device (e.g., a mouse, a keyboard) can be rendered in a display of an HMD, such as the HMD 800. The rendered input devices (e.g., the rendered mouse, the rendered keyboard) can be used as rendered in the display.

A number of implementations have been described. Nevertheless, it will be understood that various modifications may be made without departing from the spirit and scope of the description and claims.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user is provided with controls allowing the user to make an election as to both if and when systems, programs, devices, networks, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that user information is removed. For example, a user's identity may be treated so that no user information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example implementations. Example implementations, however, may be embodied in many alternate forms and should not be construed as limited to only the implementations set forth herein.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Example implementations of the concepts are described herein with reference to cross-sectional illustrations that are schematic illustrations of idealized implementations (and intermediate structures) of example implementations. As such, variations from the shapes of the illustrations as a result, for example, of manufacturing techniques and/or tolerances, are to be expected. Thus, example implementations of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example implementations.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A computer program product, the computer program product being tangibly embodied on a non-transitory computer-readable storage medium and comprising instructions that, when executed by at least one computing device, are configured to cause the at least one computing device to:
receive a transcription stream including transcribed text that has been transcribed from speech;
receive a summary request for a summary to be provided on a display of a device;
identify, from the transcribed text and in response to the summary request, extracted text;
process the extracted text using a summarization machine learning (ML) model to obtain a summary of the extracted text; and
display the summary on the display of the device.

2. The computer program product of claim 1, wherein the instructions, when executed by the at least one computing device, are further configured to cause the at least one computing device to:
receive the summary request from a user of the device, via an input device of the device.

3. The computer program product of claim 1, wherein the input device includes at least one of a touchscreen, a gesture recognition device, a scroll bar, a button, or a microphone.

4. The computer program product of claim 1, wherein the instructions, when executed by the at least one computing device, are further configured to cause the at least one computing device to:
receive the summary request as a vocal command from a user of the device, via a microphone of the device.

5. The computer program product of any one of the preceding claims, wherein the instructions, when executed by the at least one computing device, are further configured to cause the at least one computing device to:
receive the transcription stream from a speech recognition engine.

6. The computer program product of claim 1, wherein the device includes a head-mounted display (HMD) and the display includes an HMD display, and wherein the instructions, when executed by the at least one computing device, are further configured to cause the at least one computing device to:
display the transcription stream using the HMD display.

7. The computer program product of claim 1, wherein the instructions, when executed by the at least one computing device, are further configured to cause the at least one computing device to:
identify the extracted text as including text received at the device prior to the summary request; and
extract the extracted text from a transcription buffer.

8. The computer program product of claim 1, wherein the instructions, when executed by the at least one computing device, are further configured to cause the at least one computing device to:
identify the extracted text as including text received after the summary request; and
extract the extracted text from the transcription stream after the summary request.

9. The computer program product of claim 1, wherein the instructions, when executed by the at least one computing device, are further configured to cause the at least one computing device to:
generate at least two summaries using the summarization ML model, including the summary; and
select the summary from the at least two summaries based on device characteristics of the device and on user preferences of a user of the device.

10. The computer program product of claim 1, wherein the device includes a head-mounted display (HMD) and the display includes an HMD display, and wherein the instructions, when executed by the at least one computing device, are further configured to cause the at least one computing device to:
display the summary using the HMD display.

11. A device comprising:
at least one processor;
at least one memory;
at least one input device; and
at least one display, wherein instructions stored using the at least one memory, when executed by the at least one processor, cause the device to:
receive a transcription stream including transcribed text that has been transcribed from speech;
receive, via the input device, a summary request for a summary to be provided on the at least one display;
identify, from the transcribed text and in response to the summary request, extracted text;
process the extracted text using a summarization machine learning (ML) model to obtain a summary of the extracted text; and
display the summary on the at least one display.

12. The device of claim 11, wherein the device includes a head-mounted display (HMD).

13. The device of claim 11, wherein the device is configured to receive the transcription stream and the summary from a second device in communication with the device.

14. The device of claim 11, wherein the input device includes at least one of a touchscreen, a gesture recognition device, a scroll bar, a button, or a microphone.

15. The device of claim 14, wherein the input device includes a microphone, and the summary request is received as a vocal command from a user of the device, via the microphone.

16. A method comprising:
receiving a transcription stream including transcribed text that has been transcribed from speech;
receiving a summary request for a summary to be provided on a display of a device;
identifying, from the transcribed text and in response to the summary request, extracted text;
processing the extracted text using a summarization machine learning (ML) model to obtain a summary of the extracted text; and
displaying the summary on the display of the device.

17. The method of claim 16, further comprising:
storing the summary with the summary request as labeled training data; and
training the summarization ML model using the labeled training data.

18. The method of claim 17, further comprising:
detecting a second summary request using the summarization ML model after the training; and
summarizing second extracted text using the summarization ML model.

19. The method of claim 16, wherein the device includes a head-mounted display (HMD) and the display includes an HMD display, and further comprising:
displaying the summary using the HMD display.

20. The method of claim 16, further comprising:
generating at least two summaries using the summarization ML model, including the summary; and
selecting the summary from the at least two summaries based on device characteristics of the device and on user preferences of a user of the device.

21. A computer program product, the computer program product being tangibly embodied on a non-transitory computer-readable storage medium and comprising instructions that, when executed by at least one computing device, are configured to cause the at least one computing device to:
receive a transcription stream including transcribed text that has been transcribed from speech;
receive an image associated with receipt of the transcription stream;
process the transcription stream using a summarization machine learning (ML) model to obtain a summary stream, including processing the transcribed text to obtain a summary;
combine the image and the summary to obtain an augmented summary; and
display the augmented summary.

22. The computer program product of claim 21, wherein the instructions, when executed by the at least one computing device, are further configured to cause the at least one computing device to:
select a time interval based on receiving the image; and
extract the summary from a portion of the summary stream corresponding to the time interval.

23. The computer program product of claim 21, wherein the instructions, when executed by the at least one computing device, are further configured to cause the at least one computing device to:
process the transcribed text using a text entity extractor ML model to identify an entity within the transcribed text; and
display the augmented summary with the entity visually distinguished therein.

24. The computer program product of claim 21, wherein the instructions, when executed by the at least one computing device, are further configured to cause the at least one computing device to:
process the transcribed text using an emotion analyzer ML model to identify an emotion associated with the transcribed text; and
display the augmented summary with the emotion visually distinguished therein.

25. The computer program product of claim 24, wherein the emotion is indicated by inclusion of a corresponding emoji.

26. The computer program product of claim 21, wherein the instructions, when executed by the at least one computing device, are further configured to cause the at least one computing device to:
process the image using an image entity extractor ML model to identify an entity within the image; and
display the augmented summary with the entity visually distinguished therein.

27. The computer program product of claim 21, wherein the instructions, when executed by the at least one computing device, are further configured to cause the at least one computing device to:
process the transcribed text using an intent extractor ML model to identify an intention associated with the transcribed text; and
display the augmented summary with the intention visually distinguished therein.

28. The computer program product of claim 21, wherein the instructions, when executed by the at least one computing device, are further configured to cause the at least one computing device to:
combine the image and the transcribed text to obtain an augmented transcription; and
display the augmented transcription.

29. The computer program product of claim 21, wherein the at least one computing device includes a head-mounted display (HMD), and wherein the instructions, when executed by the at least one computing device, are further configured to cause the at least one computing device to:
display the augmented summary using the HMD.

30. The computer program product of claim 21, wherein the instructions, when executed by the at least one computing device, are further configured to cause the at least one computing device to:
display at least one stream of the transcription stream and the summary stream with a scroll bar having a scroll button;
receive a movement of the scroll button that aligns the scroll button with text of the transcription stream or the summary stream; and
generate the augmented summary based on a selection of the scroll button while aligned with the text.

31.-40. (canceled)
